(19) United States
(12) Patent Application Publication
(10) Pub. No.: US 2025/0299443 A1
(43) Pub. Date: Sep. 25, 2025

(54) GENERATING LANDCOVER MAPS FROM AERIAL ORTHOMOSAIC IMAGES USING GENERATIVE ARTIFICIAL INTELLIGENCE

(71) Applicant: Saudi Arabian Oil Company, Dhahran (SA)

(72) Inventors: Ahmad Ihsan Ramdani, Dhahran (SA); Pavel Golikov, Dhahran (SA)

(21) Appl. No.: 18/614,087

(22) Filed: Mar. 22, 2024

(51) Int. Cl. G06T 17/05; G06T 7/579; G06T 7/593; G06T 17/20; G06V 10/764; G06V 10/82; G06V 10/98; G06V 20/70

(52) U.S. Cl. CPC G06T 17/05; G06T 7/579; G06T 7/593; G06T 17/20; G06V 10/764; G06V 10/82; G06V 10/98; G06V 20/70; G06T 2200/24; G06T 2207/10012; G06T 2207/10028; G06T 2207/20076; G06T 2207/20081; G06T 2207/20084

(57) ABSTRACT

A method, system, and non-transitory computer readable media for landcover map generation of an environment. The operations include receiving an image captured at an aerial position above the environment, obtaining coordinate information of the environment corresponding to pixels of the image, and determining coordinate measures. The operations include generating image patches, each image patch representing a portion of the pixels and applying image processing techniques to adjust pixel values of a respective image patch. The operations include providing the adjusted image patches to a generative adversarial network (GAN) and generating landcover map patches from the adjusted image patches. The GAN includes a generator network trained to generate training landcover map patches from an image patch and a discriminator network trained to classify training landcover map patches from the generator network. The operations include generating a landcover map from the landcover map patches and providing the landcover map for output.

### TECHNICAL FIELD

This specification relates generally to image processing of aerial images of an environment, such as aerial images captured by drones and satellite images, coupled with artificial intelligence for oil and gas applications.

### BACKGROUND

Landcover maps are representations of different types of land surfaces and covers in a geographic area. A landcover map can provide information related to the distribution and features of different types of landcover classes. A landcover map can be generated from sensor data collected by remote sensors, such as satellite images and aerial images from satellites and unmanned aerial vehicles, respectively. In seismic imaging, landcover maps can characterize surface conditions of subterranean formations through the different landcover classes. Seismic imaging techniques, such as reflection seismology, are used to create subsurface images by analyzing the propagation of seismic waves through the Earth's subsurface.

The quality of seismic data can be affected by surface conditions, such as the topography, vegetation cover, and land use types for an environment. Machine learning models can be trained generate landcover maps with classification labels identifying different types of landcover classes. However, these machine learning techniques may not account for limited spatial resolution, differences in spectral features between land cover types and can introduce errors or biases that impact the reliability of the resulting landcover maps.

### SUMMARY

This specification describes a machine learning conditional generative adversarial network (cGAN) that is trained to translate orthomosaic input images of an environment into landcover maps that classifies different types of land cover for the environment. The cGAN can be trained to perform a translation of pixels from a high-resolution aerial image, such as an image captured by unmanned aerial vehicle (UAV), to a high-resolution landcover map that includes classifications of different landcovers present in the environment represented by the input translation. This approach for landcover map generation includes generating (e.g., by splitting, duplicating, segmenting) patches of a high-resolution orthomosaic image that accounts for distortive effects of aerial images (e.g., rotations, height distortions) and providing the image patches to the cGAN model configured to translate the image patches to landcover patches, representing a landcover classification of the image patches.

The approach disclosed in this specification also incorporates coordinate information of the environment from the captured input image to assemble a landcover map from the landcover patches, and the resulting landcover map is anchored using coordinate information from the original input image. This approach also includes a training process that iteratively trains a generator and one or more discriminators of the cGAN to converge to an accurate landcover map substantially faster than approaches that use pixel-by-pixel classification, e.g., classifying and associating each pixel to a particular landcover class based on feature data for the pixel.

Some approaches for landcover map generation can include machine learning techniques that perform pixel-by-pixel classification to generate a landcover map, such as ground filtering and random forest techniques. These approaches analyze features at each individual pixel to generate a classification of the landcover class. However, these approaches rely on abundant number of training images (e.g., hundreds of images) and have a runtime that correlates with a number of different landcover classes. These approaches also have substantial consumption of computational resources to classify environments with a high density of landcover classes and demand a large number of training images to account for all of the different landcover classes.

In contrast to ground filtering and random forest techniques, the cGAN can be trained using a small number of input images (e.g., tens of images) compared to hundreds or thousands of images demanded by techniques that perform pixel-by-pixel classification to generate landcover maps. Because the cGAN relies on a patch-by-patch translation approach to generate landcover map patches from input image patches, training the cGAN and performing pixel translations can be independent of the number of landcover classes. The techniques described in this disclosure can provide landcover maps accounting for high-density environments with numerous landcover classes without substantially increasing the computational runtime and reducing computational demands.

Furthermore, the higher pixel resolution (e.g., higher pixel density per square meter of an environment) of aerial images collected by UAVs relative to satellite images can significantly increase the running time of pixel-based classification methods. In contrast to random forest and ground filtering techniques that perform a classification of landcover classes at a pixel-by-pixel level, the techniques disclosed in this specification generates the landcover classes by generating patches of landcover map patches. The landcover map patches can be generated from an input image that is segmented into multiple input image patches and provided to a GAN trained to learn a translation process between patches of pixels and obtaining classification labels from the translation process, e.g., rather than classifying each individual pixel. Thus, performing a landcover classification through translations of pixels in an input image patch to a landcover map patch can significantly reduce runtime, e.g., in contrast to performing a classification of every pixel in an input image. Further, the techniques disclosed in this specification can result in lower computation demands and increased computational efficiency compared to individual pixel classification. The techniques can also be applied to satellite-based images and other types of airborne image collection from airplanes, helicopters, etc., to generate classification labels of an environment.

Embodiments of these systems and methods can include one or more of the following features to enable one or more of the foregoing advantages. Accurate landcover mapping can provide numerous advantages in seismic imaging of a subterranean formation, by determining features of different landcover classes, thereby characterizing the data quality of seismic images of the subterranean formation. For example, different types of landcover classes (e.g., terrain) can cause varying amounts of distortion in the seismic data acquired by transmitting and receiving seismic traces. Identifying and improving the accuracy of landcover maps can result in improved identification of the environment prone to interference (e.g., dense vegetation) and areas of the environment (e.g., buildings) in which the transmitters and receivers used for seismic imaging cannot be placed.

An accurate classification and characterization of landcover classes through a landcover map allows for an identification of seismic imaging sites for data acquisition. For example, the landcover map can indicate portions of the environment with a substantially small amount of distortion and/or interference inducing landcover classes, compared to other portions of the environment indicated by the landcover map with landcover classes that are likely to cause large amounts of distortion and/or including multiple sources of interference. As another example, accurate landcover mapping can also facilitate environmental impact assessments by identifying areas of ecological significance that should be protected or mitigated against potential disturbances resulting from seismic surveys.

Additional advantages of the improved landcover map generation provided by a GAN-based patch-by-patch translation include an increase in the accuracy of key features of a subterranean formation, e.g., correlating seismic data with geological features of the subterranean formation. By improving the accuracy of landcover classifications, a location for seismic imaging can be selected based on landcover class and thus enhance the accuracy of subsurface imaging, e.g., improving the overall quality of seismic imaging results. As another example, some regions of an environment, including particular types of landcover classes such as farmland and certain ecological biomes, may be regulated and restricted. These restricted regions may not permit seismic imaging (e.g., due to equipment and other potential disturbances) within a certain distance of restricted region. Thus, accurate landcover classification can improve a likelihood of seismic imaging surveys following regulations and minimize adverse impacts on the environment and local communities.

In an aspect, a computer-implemented method for landcover map generation includes receiving, by a communication network and from a digital camera situated at an aerial position above an environment, an input image including pixels and representing the environment. The method includes obtaining coordinate information of the environment corresponding to the pixels of the input image and determining, based on the coordinate information of the pixels of the input image, one or more coordinate measures for the input image. The method also includes generating, from the input image and based on the one or more coordinate measures, a plurality of input image patches, each input image patch from the plurality of input image patches representing a portion of pixels in the input image. The method includes applying, for the plurality of input image patches, one or more image processing techniques to adjust pixel values of a respective input image patch from the plurality of input image patches to generate a plurality of adjusted image patches. The method includes providing the plurality of adjusted image patches to a generative adversarial network. The generative adversarial network is trained to generate a corresponding landcover map patch for each adjusted image patch in the plurality of adjusted image patches. The method includes generating, by the generative adversarial network and using the plurality of adjusted image patches, a plurality of landcover map patches. The generative adversarial network includes a generator network trained to generate training landcover map patches from an input image patch and a discriminator network trained to classify training landcover map patches from the generator network. A classification of a training landcover map patch includes a label indicating that the training landcover map patch represents one or more landcover classes of a corresponding input image patch. The method includes generating a landcover map from the plurality of landcover map patches. Generating the landcover map includes assembling the plurality of landcover map patches according to the coordinate information of the environment. The method includes providing the landcover map corresponding to the input image for output.

In some implementations, providing the landcover map includes transmitting the landcover map to a client device, for display of the landcover map on the client device. In some implementations, providing the landcover map includes transmitting the landcover map to a computing device configured to determine positions of seismic imaging equipment according to the landcover map.

In some implementations, the landcover map includes one or more landcover classification labels, each classification label from the one or more landcover classification labels corresponding to a landcover class of the environment. At least one classification label from the one or more landcover classification labels represent an obstructed portion of the environment, the obstructed portion of the environment being likely to cause an interference in seismic imaging of the environment.

In some implementations, the input image is an orthomosaic image captured by an unmanned aerial vehicle and the coordinate information is obtained from the unmanned aerial vehicle. In some implementations, the input image is a satellite image captured by a satellite and the coordinate information is obtained from the satellite.

In some implementations, the coordinate measures include one or more of (i) a pixel size, (ii) a pixel size, (iii) a pixel coordinate, (iv) a pixel rotation about an axis of the input image, for one or more pixels of the input image.

In some implementations, generating the plurality of input image patches from the input image includes removing the coordinate information from the input image, selecting, for each input image patch in the plurality of input image patches, a portion of pixels of the input image, each input image patch in the plurality of input image patches share an identical resolution, and generating a second set of input image patches from the plurality of input image patches. Each input image patch in the second set of input image patches is a duplicate of a corresponding input image patch in the plurality of input image patches. The plurality of input image patches can be non-overlapping.

In some implementations, the generator network of the generative adversarial network includes a plurality of convolutional neural network layers, a plurality of skip connections, and a plurality of activation layers.

In some implementations, the discriminator network of the generative adversarial network includes a plurality of convolutional neural network layers and a plurality of activation layers.

In some implementations, one or more channels of the input image includes a frequency band of visible light. In some implementations, one or more channels of the input image includes a frequency band of infrared.

In some implementations, the generative adversarial network is a condition generative adversarial network, and the method includes obtaining a training set of input landcover map patches corresponding to the environment captured by the input image, generating, by the generator network and using the plurality of input image patches, a plurality of output landcover map patches, each output landcover map patch from the plurality of output landcover map patches corresponding to an input image patch from the plurality of input image patches. The method includes providing the plurality of output landcover map patches to the discriminator network and determining, by the discriminator network and for each output landcover map patch from the plurality of output landcover map patches, a classification label indicating that the output landcover map patch correctly identifies one or more landcover classes of the corresponding input image patch. The method includes determining, based on the classification label, an error between the plurality of output landcover map patches and the training set of input landcover map patches, and in response to determining that the error exceeds a threshold value, updating one or more parameters of the generator network or the discriminator network.

In an aspect, a computer-implemented system for landcover map generation includes at least one processor and a memory storing instructions that, when executed by the at least one processor, cause the at least one processor to perform operations. The operations include receiving, by a communication network and from a digital camera situated at an aerial position above an environment, an input image including pixels and representing the environment. The operations include obtaining coordinate information of the environment corresponding to the pixels of the input image and determining, based on the coordinate information of the pixels of the input image, one or more coordinate measures for the input image. The operations also include generating, from the input image and based on the one or more coordinate measures, a plurality of input image patches, each input image patch from the plurality of input image patches representing a portion of pixels in the input image. The operations include applying, for the plurality of input image patches, one or more image processing techniques to adjust pixel values of a respective input image patch from the plurality of input image patches to generate a plurality of adjusted image patches. The operations include providing the plurality of adjusted image patches to a generative adversarial network. The generative adversarial network is trained to generate a corresponding landcover map patch for each adjusted image patch in the plurality of adjusted image patches. The operations include generating, by the generative adversarial network and using the plurality of adjusted image patches, a plurality of landcover map patches. The generative adversarial network includes a generator network trained to generate training landcover map patches from an input image patch and a discriminator network trained to classify training landcover map patches from the generator network. A classification of a training landcover map patch includes a label indicating that the training landcover map patch represents one or more landcover classes of a corresponding input image patch. The operations include generating a landcover map from the plurality of landcover map patches. Generating the landcover map includes assembling the plurality of landcover map patches according to the coordinate information of the environment. The operations include providing the landcover map corresponding to the input image for output.

In some implementations, providing the landcover map includes transmitting the landcover map to a client device, for display of the landcover map on the client device. In some implementations, providing the landcover map includes transmitting the landcover map to a computing device configured to determine positions of seismic imaging equipment according to the landcover map.

In an aspect, one or more non-transitory computer readable media storing instructions for landcover map generation, wherein the instructions, when executed by at least one processor, cause the at least one processor to perform operations. The operations include receiving, by a communication network and from a digital camera situated at an aerial position above an environment, an input image including pixels and representing the environment. The operations include obtaining coordinate information of the environment corresponding to the pixels of the input image and determining, based on the coordinate information of the pixels of the input image, one or more coordinate measures for the input image. The operations also include generating, from the input image and based on the one or more coordinate measures, a plurality of input image patches, each input image patch from the plurality of input image patches representing a portion of pixels in the input image. The operations include applying, for the plurality of input image patches, one or more image processing techniques to adjust pixel values of a respective input image patch from the plurality of input image patches to generate a plurality of adjusted image patches. The operations include providing the plurality of adjusted image patches to a generative adversarial network. The generative adversarial network is trained to generate a corresponding landcover map patch for each adjusted image patch in the plurality of adjusted image patches. The operations include generating, by the generative adversarial network and using the plurality of adjusted image patches, a plurality of landcover map patches. The generative adversarial network includes a generator network trained to generate training landcover map patches from an input image patch and a discriminator network trained to classify training landcover map patches from the generator network. A classification of a training landcover map patch includes a label indicating that the training landcover map patch represents one or more landcover classes of a corresponding input image patch. The operations include generating a landcover map from the plurality of landcover map patches. Generating the landcover map includes assembling the plurality of landcover map patches according to the coordinate information of the environment. The operations include providing the landcover map corresponding to the input image for output.

In some implementations, providing the landcover map includes transmitting the landcover map to a client device, for display of the landcover map on the client device.

The details of one or more embodiments are set forth in the accompanying drawings and the description below. Other features and advantages will be apparent from the description and drawings, and from the claims.

### BRIEF DESCRIPTION OF THE DRAWINGS

FIG. 1 is a schematic view of an environment with remote sensors to capture aerial images of the environment and generate landcover maps, according to an implementation of the present disclosure.

FIG. 2A illustrates an example system for generating landcover maps and data of an environment based on the aerial images using a generative adversarial network, according to an implementation of the present disclosure.

FIG. 2B illustrates an example of an input image and a landcover map generated from the input image using a generative adversarial network, according to an implementation of the present disclosure.

FIG. 2C illustrates an example bar chart comparing Kappa indices for different landcover classes, according to an implementation of the present disclosure.

FIG. 2D illustrates another example bar chart comparing metrics for landcover maps generated by generative adversarial network compared to other techniques, according to an implementation of the present disclosure.

FIG. 3 illustrates an example generative adversarial network for generating landcover maps and data of an environment based on the aerial images, according to an implementation of the present disclosure.

FIG. 4 depicts an example landcover map system for image translation from aerial images of an environment into landcover maps for the environment, according to an implementation of the present disclosure.

FIG. 5 depicts an example geographical information module of the landcover map system of FIG. 4, according to an implementation of the present disclosure.

FIG. 6 depicts an example coordinate pixel identification module of the geographical information module of FIGS. 4 and FIG. 5, according to an implementation of the present disclosure.

FIG. 7 depicts an example image processing module of the landcover map system of FIG. 4, according to an implementation of the present disclosure.

FIG. 8 depicts an example model training module of the landcover map system of FIG. 4, according to an implementation of the present disclosure.

FIG. 9 depicts an example image augmentation submodule of the model training module of FIG. 8, according to an implementation of the present disclosure.

FIG. 10 depicts an example conditional generative adversarial network (cGAN) submodule of the model training module of FIG. 8, according to an implementation of the present disclosure.

FIG. 11 depicts an example generator network of the cGAN submodule of FIG. 10, according to an implementation of the present disclosure.

FIG. 12 depicts an example discriminator network of the cGAN submodule of FIG. 10, according to an implementation of the present disclosure.

FIG. 13 depicts an example model application module of the landcover map system of FIG. 4, according to an implementation of the present disclosure.

FIG. 14 depicts an example landcover map assembly module of the landcover map system of FIG. 4, according to an implementation of the present disclosure.

FIG. 15 illustrates an example process for generating landcover maps of an environment using a generative adversarial network and aerial images of the environment, according to an implementation of the present disclosure.

FIG. 16 illustrates an example process for training the generative adversarial network, according to an implementation of the present disclosure.

FIG. 17 is a diagram of an example data processing system, according to an implementation of the present disclosure.

FIG. 18 illustrates hydrocarbon production operations that include both one or more field operations and one or more computational operations, which exchange information and control exploration for the production of hydrocarbons, according to an implementation of the present disclosure.

Like reference numbers and designations in the various drawings indicate like elements.

### DETAILED DESCRIPTION

The following detailed description describes a machine learning conditional generative adversarial network (cGAN) that is trained to translate orthomosaic input images of an environment into landcover maps that classifies different types of land cover for the environment. and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

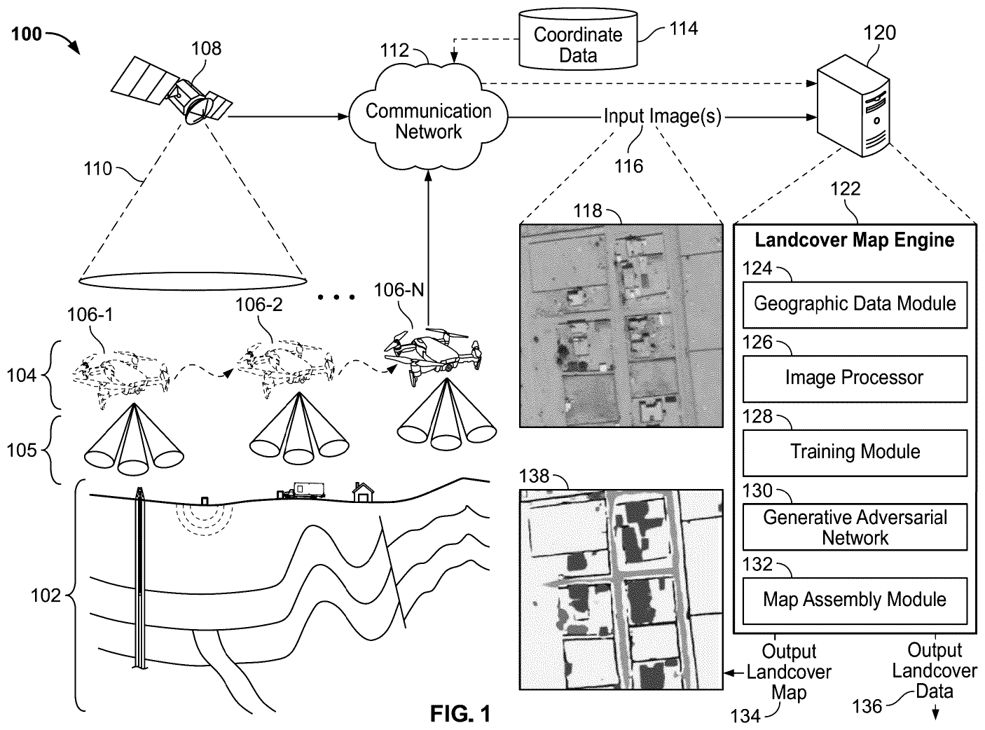

FIG. 1 is a schematic view 100 of an environment 102 with remote sensors 106 and 108 to capture aerial images 116 of the environment 102 and generate landcover maps 134 and 138, according to an implementation of the present disclosure. A computing device 120 can be configured to generate landcover maps of the environment 102. A landcover map of environment includes classifications indicating different types and patterns of land covers (e.g., coverage and uses of a surface of an environment). Examples of land cover classes can include different types of vegetation (e.g., trees, grassland), including a lack of vegetation (e.g., bare ground, asphalt, water). Other examples of land cover classes can include buildings, fences, dirt piles, offroad tracks, berms, trees, active farms, inactive farms, bare land, hills, and sediment deposits.

As described in this specification, an aerial image can be an image captured by a camera from an aerial position (i.e., at a height relative to a ground surface of the environment 102). An example of the aerial image can include an orthophoto image, e.g., an image in which the distortive effects from capturing an image from a height of the environment 102 are corrected. An aerial image can also include an orthomosaic image, which is a mosaic of multiple orthophoto images of the environment stitched together to create a single orthomosaic photo of the environment 102. The distortive effects from capturing an aerial image of an environment 102 can include radial displacement, height distortion, tilt displacement, (among other types of geometric distortions). These distortions can result from variations that in camera tilt of the camera device capturing images of the environment 102, and variations in the terrain (e.g., the landcover classes and associated features of the landcover classes) of the environment 102.

The view 100 depicts the environment 102 having a transmission-based framework for seismic imaging of a subterranean formation and can include equipment for extracting hydrocarbons (e.g., oil, natural gas) from underneath a surface of the subterranean formation. The transmission-based framework for seismic imaging of the environment 102 includes transmitting and receiving seismic waves between a controlled seismic source and a group of receivers. The view 100 depicts a seismic survey of the environment 102, which includes mapping subterranean features such as facies and faults. The subterranean formation of the environment 102 can include layers of sandstone, sand, limestone, and other features such as fault lines across different layers of the subterranean formation. Because oil and gas tend to rise through permeable reservoir rock of the subterranean formation until further upward migration is blocked, seismic surveys can be used to identify locations where interaction between layers of the subterranean formation 100 are likely to trap oil and gas by limiting this upward migration.

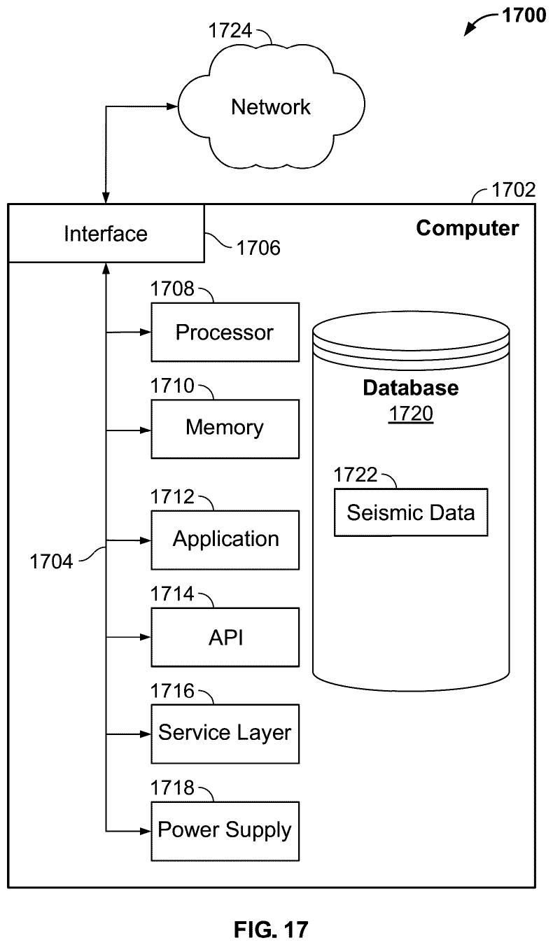

The view 100 depicts remote sensors 104 and 106 as an unmanned aircraft 104 (e.g., an unmanned aerial vehicle, a drone) and a satellite 108, respectively. The remote sensors 104 and 106 are configured to monitor and capture one or more input images 116 of the environment 102. The input image 116 can be provided to computing device 120 through a communication network 112. The computing device 120 can configured to generate an output landcover map 134 that represents a map of different landcover classes for the surface of the environment 102. Examples of communication network 112 include a local area network (LAN), a wide area network (WAN), and the Internet. The computing device 120 can also be referred to as a data processing system, described in reference to FIG. 17 below.

The computing device 120 can also be configured to generate output landcover data 136 (also referred to as “output landcover feature data 136”) that represents feature data and statistical observations about the landcover classes of the environment 102. For example, the output landcover data 136 can a probability of a region of the image being associated with a particular landcover class and any associated landcover features associated with the particular landcover class.

The unmanned aircraft 104 (also referred to as “aircraft 104”) is depicted as following a trajectory along various positions 106-1 through 106-N (collectively referred to as “trajectory 106”) above the environment 102. The aircraft 104 can include onboard cameras, e.g., digital cameras configured to capture images of the environment 102 and its surroundings. The aircraft 104 is depicted with different fields of view 105 to capture different portions of the environment 102 by adjusting by changing an angle of orientation of the digital camera to capture different input images 116 at different angles. In some cases, the angle of orientation can be adjusted by a tilting movement of the aircraft 104.

The satellite 108 captures images through onboard sensors that are configured to capture measurements at different frequency bands of the electromagnetic spectrum, e.g., through energy reflected or refracted from the environment 102. For example, the satellite 108 can include infrared (IR) sensors to capture IR measurements (e.g., signals representing IR energy reflected or refracted) from the environment 102. In some implementations, the satellite 108 transmits a beam 110 to scan the environment and collects detection data from reflections and/or refractions associated with the transmitted beam 115. For example, the satellite 108 can include onboard radar transmitters and receivers to perform radar imaging (e.g., through synthetic aperture radar techniques) of the environment 102.

One or both of the satellite 108 and the aircraft 104 can be configured to surveil and capture images of the environment 102. The input images 116 obtained by the aircraft 104 and the satellite 108 can include high-resolution images that are captured in near real-time. In some cases, multiple input images 116 are collected periodically (e.g., daily, a few times a day, hourly), continually, etc. to provide time-series images of the environment 102. In some implementations, the resolution of an input image 116 can be a high-definition resolution image (e.g., 8000 pixels by 8000 pixels) of the environment 102. An input image 116 captured by a remote sensor such as satellite 108, or an unmanned aerial vehicle (UAV), e.g., aircraft 104, can be any type of aerial image, e.g., an orthophoto, an orthomosaic.

In some implementations, multiple input images 116, e.g., capturing images of different portions of the environment 102, can be provided to the computing device 120. The computing device 120 can be configured to generate a single output landcover map 134 from the multiple input images 116 but can also be configured to generate multiple landcover maps 134 from multiple input images 116, e.g., different subsets of input images 116 corresponding to different landcover maps 134. Although FIG. 1 depicts a single satellite 108 and a single aircraft 104 as capturing images from the environment 102, any number of remote sensors can be configured to capture images of the environment 102.

Referring to the computing device 120 of FIG. 1, the computing device 120 can receive an example orthophoto image 118. The orthophoto image 118 includes pixel data representing features of the environment 102 captured at a height (e.g., an elevation) of the aircraft 104 relative to the environment 102. The pixel data can include values representing the features in any appropriate format, e.g., red-green-blue values. In some implementations, coordinate data 114 representing coordinates of the environment captured by the input image 116 (including orthophoto image 118) can be provided to the computing device 120. For example, global positioning system (GPS) coordinates that include latitude and longitude information can be directly provided to the computing device 120 and/or through the communication network 112. In some implementations, images collected by the remote sensors can include coordinate information determined by the respective remote sensor. For example, the aircraft 104 can include a global positioning system that provides real-time, or near real-time, coordinates of aircraft 104 as the aircraft 104 captures images over the environment 102.

The computing device 120 includes a landcover map engine 122 with a number of modules and components illustrated in FIG. 1. The landcover map engine 122 is configured to generate the output landcover map 134 and the output landcover data 136, based on the input image 116 provided. For example, landcover map 138 illustrates different landcover classes, each landcover class having a corresponding classification label indicating the type of landcover class, e.g., a color-coded map of the different landcover classes. In some implementations, the landcover map 138 can also include classification labels indicating an obstruction of the portion of the environment 102 captured in the image 118 or input image 116. For example, a subset of landcover classes can correspond to a high-level classification indicating obstructions at the associated regions of the environment representation by the landcover map 134 or 138.

In some implementations, the computing device 120 is configured to display the one or both of the output landcover map 134 and the output landcover data 136. In some implementations, the computing device 120 can be configured to provide the landcover map to one or more external computing devices. The external computing devices can be configured to determine positions of seismic imaging equipment (e.g., receivers, sensors, transmitters) according to the landcover map.

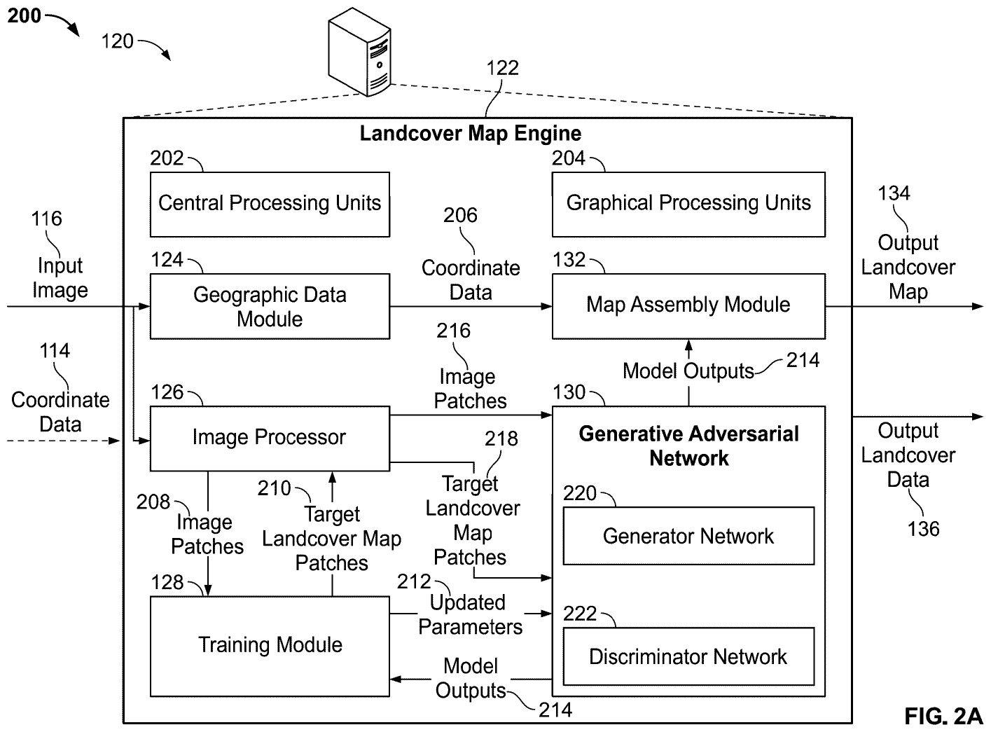

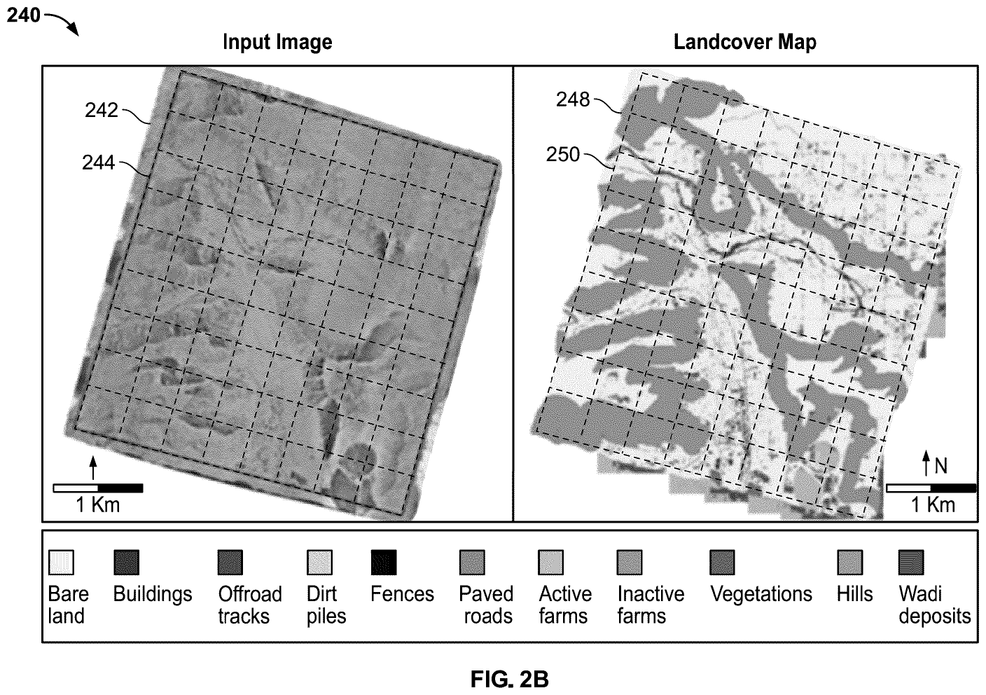

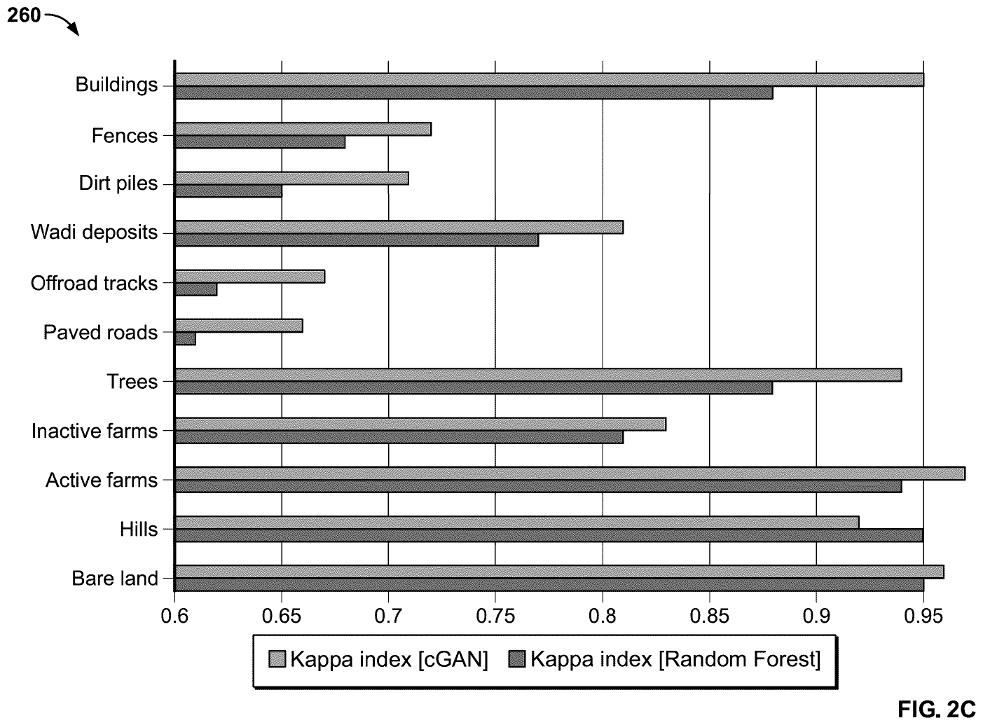

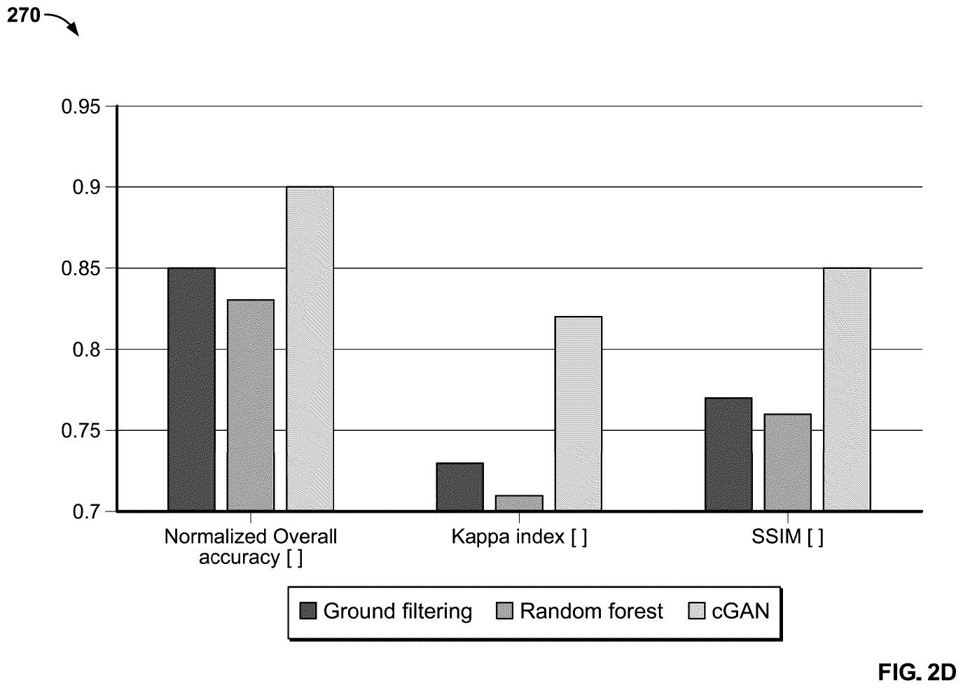

The landcover map engine 122 includes as a geographic data module 124, an image processor 126, a training module 128, a generative adversarial network 130, and a map assembly module 132. Further description of the landcover map engine 122 is described in reference to FIG. 2A below.

In some cases, aerial images from a satellite (e.g., satellite 108) may not provide sufficient resolution for landcover generation, thereby resulting in poor or inaccurate classification of landcover classes in an environment 102. In some implementations, aerial images from UAVs (e.g., aircraft 104) equipped with high-resolution (e.g., relative to the resolution of an image captured by a satellite) digital cameras can be configured to capture high-resolution images of the environment. The resulting classification labels of a landcover map generated from high-resolution aerial images captured by a UAV are more likely to have a higher accuracy in correctly identifying the landcover classes of an environment, e.g., compared to a landcover map generated from satellite images.

FIG. 2A illustrates an example system 200 for generating landcover maps and data of an environment 102 based on the aerial images using a conditional generative adversarial network 130, according to an implementation of the present disclosure. The system 200 shows the computing device 120 of FIG. 1 receiving input images 116 (e.g., an orthophoto image 118) and coordinate data 114 (e.g., latitude and longitudinal coordinates of the environment captured by the orthophoto image).

The cGAN 130 is trained to perform translations between input image patches 216 from an input image 116 to the output landcover patches 214, by learning image-to-image translations between features of pixels in an input image patch and features of landcover maps in an output landcover patch that corresponds to portion of the environment representation by the input image patch. For example, the landcover map engine 122 can obtain the input image 116 identify coordinate information associated with the input image through the geographic data module 124. In some cases, the coordinate data 114 can include elevation information, e.g., a height from the surface of an environment, for an aircraft that captured the input images.

The landcover map engine 122 configures the geographic data module 124 to identify geographical coordinates corresponding to regions of the environment represented by the input images. In some implementations, the geographic data module 124 can be configured to identify the geographical coordinate for the input image 116, e.g., by receiving additional data from the coordinate data 114 corresponding to the input image 116. In some implementations, the geographic data module 124 is configured to extract coordinate information from metadata of the input image. The metadata of the input image can be provided from the source of the input image, e.g., a digital camera mounted onto an aircraft. For example, GPS coordinates from the UAV can be recorded by the UAV and provided with the input images captured by the UAV to the landcover map engine 122. From the input image 116 and/or the coordinate data 114, the geographic data module 124 generates a coordinate file 206 that maintains a record of geographical information associated with the input image, which can be used to assembly landcover map patches to obtain an output landcover map 134 with the same coordinate information as the input image 116. By doing so, the landcover map engine 122 can reduce computational complexity by removing the geographic information from the input image 116 prior to training and classifying to generate the output landcover map 134.

The system 200 shows an image processor 126 that is configured to generate a first set of input image patches 208 for training and a second set of image patches 216. An image patch from an input image can be generated by segmenting the image into smaller, equal-sized image patches. The patches can overlap or non-overlap in any pixel size smaller than the shape of the input image. In some implementations, an image patch can be generated by extracting smaller regions (e.g., rectangular shaped, square shaped) from the input image, with a target patch size and stride (e.g., an amount of overlap). The pixel data for a patch can be extracted from an original input image to generate the corresponding patch.

The landcover map engine 122, e.g., by the training module 128 and the cGAN 130, can be configured to generate output landcover map patches at a target patch size that provides sufficient spatial resolution for classifying features and achieves a target sensitivity in classifying landcover types. For example, a patch size that is too small (e.g., relative to the target patch size) can fail or result in poor accuracy of particular landcover types, while a patch size that is too large (e.g., relative to the target patch size) can result in a substantial computational complexity and consumption of computing resources. In some implementations, the cGAN 130 can be configured to determine a target patch size, according to different types of landcover classes, to generate a landcover map with classification labels for different landcover types. The cGAN 130 can be trained to determine a patch size that balances between sufficient spatial resolution and computational processing loads for generating landcover maps.

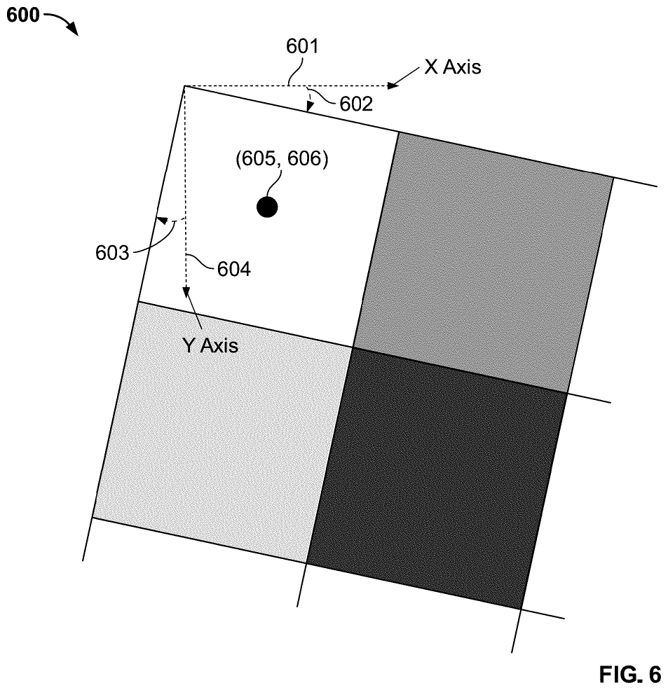

In some implementations, each patch from the input image patches generated by the landcover map engine 122 can include an anchoring pixel that maintains coordinate information while the input image patch is translated into a target landcover patch. By doing so, the landcover map engine 122 can assemble the target landcover patches using the anchoring pixels into a single output landcover map 134. The coordinate file 206 can be used to add back the geographical information to all of the pixels in the output landcover map 134, using the anchoring pixels of each landcover map patch as a reference. In some implementations, the landcover map engine 122 can be configured to determine coordinate measures such as pixel size, rotation, center coordinate information, further described in reference to FIG. 6 below.

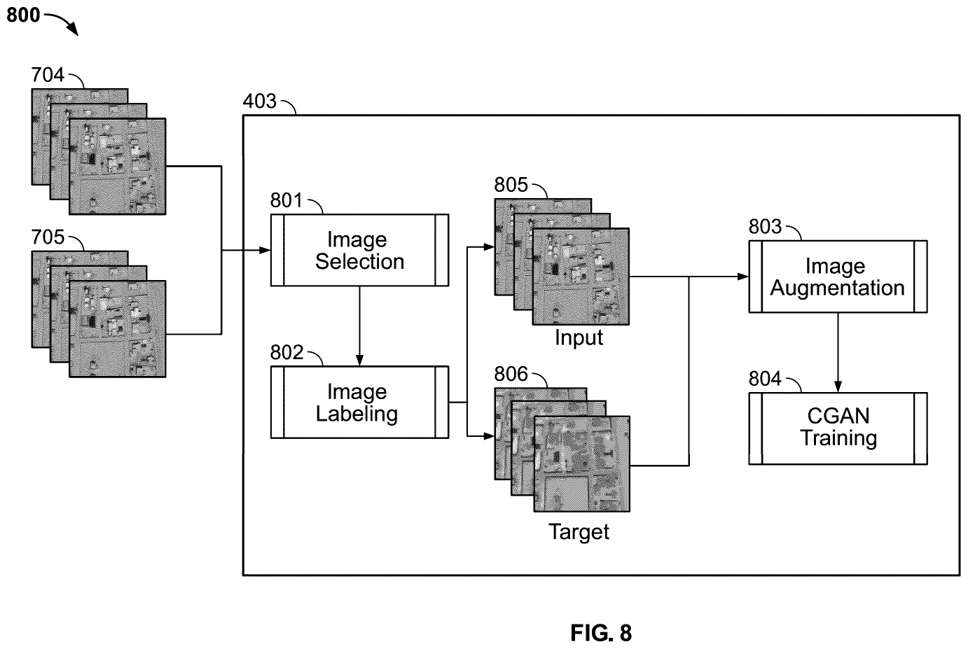

The input patches 208 can be provided to a training module 128 configured to generate target landcover map patches 210, which can include using image labeling techniques with a known landcover patch, e.g., a landcover map patch with known landcover map classifications that corresponds to an input patch, described further in reference to FIG. 8 below. The training module 128 can be configured to perform a variety of training techniques to adjust image patches and generate target landcover map patches 210. The training techniques can include supervised and unsupervised learning techniques. In some implementations, the training module 128 performs hybrid-learning techniques to improve accuracy of generating landcover maps with landcover classification labels of the surface of the environment 102. The training module 128 can adjust one or more weights or parameters for the cGAN 130, e.g., through updated parameters 212 provided to the cGAN 130. The By doing so, the landcover map engine 122 improves the accuracy of model output 214 generated by the cGAN 130, such as an output landcover map 134 and output landcover data 136. In some implementations, networks of the landcover map engine 122 include one or more fully or partially connected layers. Each of the layers can include one or more parameter values indicating an output of the layers.

The landcover map engine 122 is configured to provide the input image patches 216 (e.g., from the image processor 126) and the target landcover map patches 218 (e.g., from the image processor 126 and/or the training module 128) to the cGAN 130. The image processor 126 can be configured to apply one or more image processing techniques to generate the input image patches 216, which can include image enhancement, histogram equalization, edge sharpening, noise reduction, resizing, normalization, data augmentation (e.g., rotation, flipping, cropping, and translation), among others. An augmented image patch can be referred to as an adjusted image patch, and multiple image patches can be referred to adjusted image patches. In some implementations, the input image patches 216 can be the same image patches as the input image patches 208 provided to the training module, and the target landcover map patches 218 can be the same landcover map patches as the target landcover map patches 210. In some cases, the image patches 216 can be different patches compared to the image patches 208 by applying image processing techniques, thereby improving the likelihood of the cGAN 130 handling a wider range of possible inputs, e.g., compared to processing image patches without applying the image processing techniques.

The cGAN 130 includes a generator network 220 that is configured to generate translations of image patches to landcover map patches, by learning how to generate “fake” or synthetic landcover map patches. The cGAN 130 includes a discriminator network 222 that is configured to discriminate the landcover map patches generated by the generator network 220. By training the generator network 220 and the discriminator network 222 in an adversarial manner through a number of training steps and iterations, the cGAN 130 can learn translations and improve the performance of the generator network 220 and the discriminator network 222. For example, improved performance by the generator network 220 can appear as generating landcover map patches that are incorrectly classified as “real” (e.g., a ground truth landcover map patch) or “fake” (e.g., a landcover map patch generated by the generator network 220) by the discriminator network 222. An improved performance by the discriminator network 222 can appear as successfully discriminating the generated landcover map patches as a ground truth landcover map patch from a real set of landcover map patches, or a synthesized landcover map patch generated by the generator network 220. In this way, the generator network 220 of the cGAN 130 can improve its ability to generate landcover map patches that have a substantial likelihood of being a ground truth landcover map patch for an input image patch.

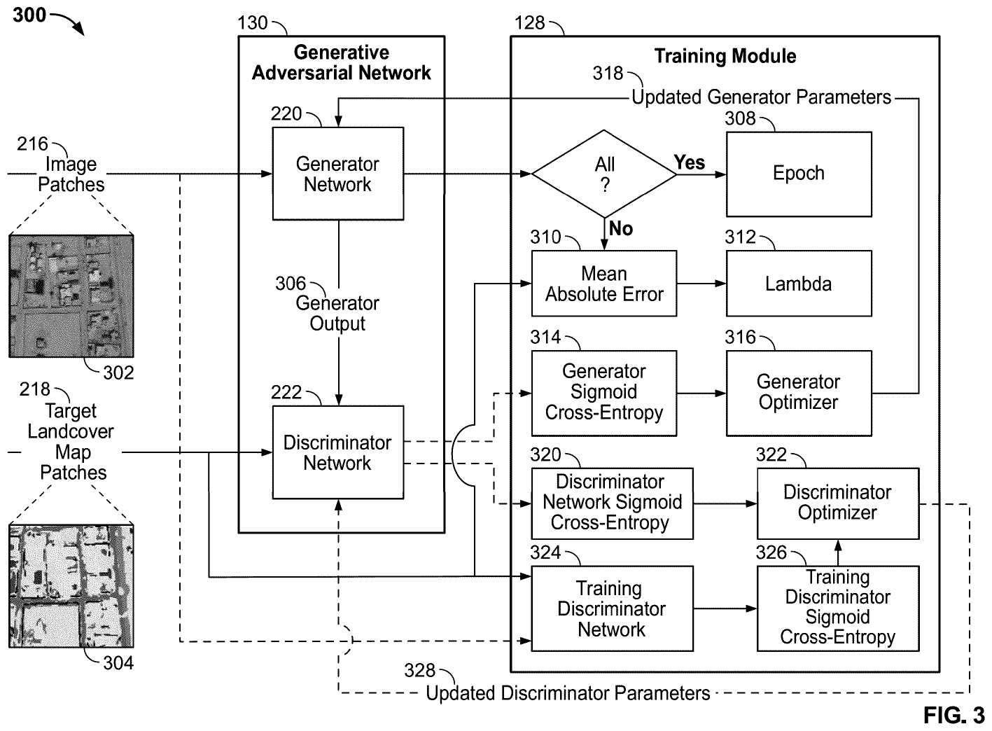

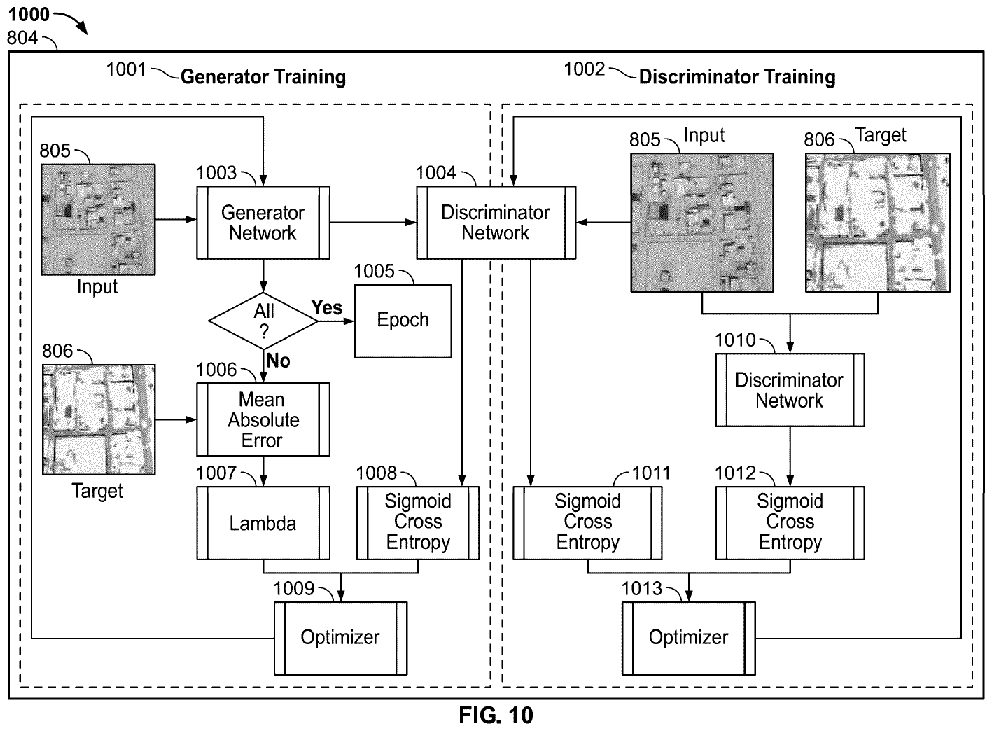

Although FIG. 2A depicts the cGAN 130 having a single generator network 220 and a single discriminator network 222, the cGAN 130 can include multiple generator networks 220 and multiple discriminator networks 222. For example, FIGS. 3 and 10 depict a generative adversarial network with multiple discriminator networks.

In some implementations, having multiple discriminators can provide improved discrimination of output patches generated by the generator network 220. The cGAN 130 can include multiple discriminator networks 222, with each discriminator network 222 being configured to focus on different types of features associated with different landcover classes, to translate the input image patches to an output landcover patch. By having each discriminator focused on different sets of features in the pixel data of the input image patch, multiple discriminators can provide improved training stability and improved quality of generated landcover patches generated by the generator network 220. As another advantage, having multiple discriminator networks 220 trained on different sets of features associated with different types of landcover classes can also increase accuracy by representing a larger portion of a distribution of the landcover classes, e.g., compared to a single discriminator network 222. By learning translations of image patch features to landcover patch features, the multiple discriminator networks 222 can provide robustness against mode collapse of the generator network 220, thereby training the generator network 220 to account for a broader range of features when attempting to generate a landcover map patch that the discriminator networks 222 can classify as a ground truth landcover map patch.

In some implementations, the cGAN 130 is a conditional generative adversarial network trained to perform image patch to landcover patch translation conditioned on multiple variables. For example, the generator network 220 and the discriminator network 222 of the GAN 130 can be trained on classification labels, conditioning the GAN 130 for landcover map generation. By conditioning the generator network 220 and the discriminator network 222, the generator network is configured to generating landcover map patches that focus on translating the patches to landcover classes and considers features about different landcover classes when generating the landcover map patches. Similarly, the discriminator network 222 can be conditioned on the landcover classes, so that the discriminator network 222 considers features about different landcover classes when discriminating the landcover map patches from the generator network 220.

The system 200 shows the cGAN 130 of FIG. 1 generating model outputs 214, which can also be referred to as output landcover patches 214. The output landcover patches 214 can be provided to a map assembly module 132, which can be configured to arrange the output landcover patches 214 into an output landcover map 134 based on the coordinate file 206 provided by the geographic data module 124. As discussed in reference to FIG. 1 above, the coordinate data from the geographic data module 124 provides that the geographic location that corresponds to the portion of the environment 102 captured by an input image patch is also translated to the corresponding output image patch for the input image patch.

The landcover map engine 122 includes central processing units (CPUs) 202 and graphical processing units (GPUs) 204 to support the computations demanded by training and applying the cGAN 130 to generate landcover maps. The landcover map engine 122 can include the CPUs, each CPU having any number of cores to process data for the cGAN 130. For example, the cGAN 130 can utilize the CPUs 202 to perform data preprocessing tasks, model training tasks, and classification tasks, for the cGAN 130. Similarly, any number of GPUs 204 can be included in the landcover map engine 122 and configured to parallelize processes performed by the landcover map engine 122 to train the cGAN 130 and translate input patches into landcover image patches.

FIG. 2B illustrates an example 240 of an input image (e.g., an orthomosaic image 118 of FIG. 1) and a landcover map 248 (e.g., output landcover map 138) generated from the input image 242 using the cGAN 130, according to an implementation of the present disclosure.

The example 240 also shows a legend 246 indicating different classes of landcover classified by the output landcover map 248. The classes of landcover include bare land, buildings, offroad tracks, dirt piles, fences, paved roads, active farms, inactive farms, vegetation, hills, and wadi deposits. FIG. 2B also illustrates the input image 242 segmented into a number of input image patches 244 (e.g., image patches 208) and the output landcover map 138 segmented into a number of output landcover patches 254. Although the input image patches 244 is depicted in FIG. 2A as an array of non-overlapping input image patches 244, the input image patches 244 can be segmented such that some or all of the patches at least partially overlap. The arrangement of the input image patches 244 need not be an array with the same number of patches in each dimension of the input image 242. The dimensionality and arrangement of output patches for the output landcover patches 254 can match the dimensionality and arrangement of input patches from the input image patches 244 provided for input to the cGAN 130 to generate the corresponding landcover map 248.

FIG. 2C illustrates an example bar chart 260 comparing Kappa indices for different landcover classes, according to an implementation of the present disclosure. For example, the bar chart 260 compares Kappa indices for different landcover classes generated by the cGAN 130 compared to an approach that performs classification for each individual pixel of an input image, e.g., random forest. Although FIG. 2C shows a comparison of a Kappa index (e.g., an index ranging from −1 to 1, with higher values indicating better agreement between a predicted classification label and a ground truth label) for each technique of generating landcover maps, any appropriate metric for evaluating an agreement between predicted and actual classifications for landcover map generation may be used. As shown in FIG. 2C, the Kappa index for each landcover class is higher for landcover a landcover map generated by the cGAN 130 compared to the Kappa index for each landcover class from a landcover map generated by a random forest approach. Thus, the cGAN 130 demonstrates an improved agreement between ground truth landcover classification labels and predicted landcover classification labels than the random forest approach.

FIG. 2D illustrates another example bar chart 270 comparing metrics for landcover maps generated by the cGAN 130 compared to other techniques, according to an implementation of the present disclosure. The bar chart 270 compares metrics for landcover maps generated by generative adversarial network compared to other approaches for landcover map generation that rely on pixel-by-pixel classification. For example, the bar chart 270 shows a comparison between a ground filtering approach, a random forest approach, and the GAN approach for generating landcover maps. The bar chart 270 shows a normalized overall accuracy metric, a Kappa index metric, and a Structured Similarity Index Measure (SSIM), for all three approaches. The normalized overall accuracy metric can be a measure of a number of correctly classified landcover classes in a landcover map generated from an input image, accounting for the distribution of the different landcover classes identified in the landcover map. The SSIM is a metric between a ground truth landcover map and the output landcover map generated by a respective approach, and compares the luminance, contrast, and structures between the ground truth landcover map and the output landcover map. As shown by bar chart 270, the cGAN approach demonstrates a higher normalized overall accuracy, Kappa index, and SSIM for generating landcover maps compared to the ground filtering and random forest approaches.

FIG. 3 illustrates an example cGAN 130 for generating landcover maps and data of an environment 102 based on the aerial images 116, according to an implementation of the present disclosure. The diagram 300 shows steps performed by the training module 128, the generator network 220, and the discriminator network 220, to provide a generator output 306 for landcover classification. For example, an image patch 302 from the image patches 216 can be provided to the generator network 220 and a target landcover map patch 304 from the target landcover map patches 218 can be provided to the discriminator network 222. In this way, the generator network 220 can be configured to generate a synthetic output landcover patch for discrimination (e.g., detecting whether or not the synthetic landcover patch) is real by the discriminator network 222.

The cGAN 130 can be configured by the training module to perform a number of training steps that can be performed sequentially on a patch-by-patch basis, e.g., each patch from a set of image patches can be provided to the generator network 220 to generate the synthetic output, depicted as generator output 306, that is then provided to the discriminator network 222. The discriminator network 222 compares the generator output 306 (e.g., an output landcover map patch) to the target landcover map patch 304 and can be trained to identify which of the generator output 306 and the target landcover map patch 304. Upon the discriminator network 222 correctly classifying the generator output 306 as the synthetic output from the generator (e.g., indicating a successful detection of the synthetic output), the training module 128 can update parameters for the generator network 220 and a new landcover map patch can be generated. The new landcover map patch is an updated generator output 306 (e.g., a new synthetic output) corresponding to the input patch 302 that can be more likely to be classified a ground truth measurement in the next training step. If the discriminator network 222 incorrectly classifies the generator output 306 as a “real” landcover map output patch, e.g., the generator output 306 is classified as a ground truth measurement, the training module 128 can update parameters for the discriminator network 222 and another comparison step can be performed.

The steps for generating updated generator parameters 318 include a generator sigmoid cross-entropy step 314 and a generator optimizer step 316. The sigmoid cross-entropy step 314 can include a loss function for the generator output 306 and the generator network 220, by applying the sigmoid function to the generator output 306 and determining a cross-entropy loss. Applying the sigmoid function embeds the likelihood of different landcover types into a predicted probability of the landcover class being a correct type. The cross-entropy loss is a difference between the predicted probability of the landcover class being a correct type to ground truth labels indicating the type of landcover for an image patch, and a loss function for the error of the generator network 220 can be formed.

The generator sigmoid cross-entropy step 314 penalizes the generator network 220 for an incorrect landcover class, to improve likelihoods of correct landcover type classification. The generator optimizer step 316 includes applying an optimization technique to identify the updated generator parameters 318 that minimizes the loss function from the generator sigmoid cross-entropy step 314. In some implementations, the optimization techniques include stochastic gradient descent (SGD), Adaptive Moment Estimation (Adam), among other types of solvers. Minimizing the loss function and identifying the parameters corresponding to the loss function minimum provides the generator network 220 improves its ability to generate landcover map patches during the training process. The generator sigmoid cross-entropy step 314 can also obtain an output classification result from the discriminator network 222 to account for the performance of the discriminator network 222 when adjusting the generator parameters.

The steps for generating updated discriminator parameters 328 include a discriminator network sigmoid cross-entropy step 320 and a discriminator optimizer step 322 that run in parallel to a training discriminator network 324 step and a training discriminator sigmoid cross-entropy step 326. The training discriminator network 324 step and the training discriminator sigmoid cross-entropy step 326 can be an independent evaluation of a target landcover map patch 304 (e.g., a ground truth measurement representing a patch of a known landcover map) to train the discriminator network 222 without a generator output 306. Similar to the generator sigmoid cross-entropy step 314, the discriminator sigmoid cross-entropy step 320 and the discriminator sigmoid cross-entropy step 326 include applying a sigmoid function and determining a cross-entropy loss to form a loss function.

The discriminator optimizer 322 can minimize two loss functions simultaneously: a first loss function from the discriminator sigmoid cross-entropy step 320 and a second loss function from the training discriminator sigmoid cross-entropy step 326. Minimizing multiple loss functions for multiple discriminator networks provides updated discriminator parameters 328 that have a higher likelihood of correctly classifying real landcover map patches as ground truth measurements and fake landcover map patches (e.g., generator output 306) as a synthetic output from a generator network. Similar to the generator optimizer 316, the discriminator optimizer 322 can use a number of optimization techniques to minimize a loss function.

The training module 128 can be configured to perform an evaluation for the number of training steps performed for training the generator network 220 and the discriminator network 222 of the cGAN 130. An index of the generator output 306 indicating a patch number of an input patch from a set of patches can be evaluated. For each subsequent landcover map patch generated for a set of patches, a mean absolute error (MAE) step 310 can be computed using the corresponding target landcover map patch from the target landcover map patches 218. The MAE step 310 can be determined by averaging the magnitude of pixel differences between the generator results (e.g., generator output 306) and the target landcover map, e.g., from one or more target landcover map patches 218.

A lambda parameter 312 can be adjusted to perform a regularization of the training process to penalize the training module 128 from training the cGAN 130 such that the cGAN 130 overfits to the training data, e.g., target landcover map patches 218. Upon generating a landcover map patch for the last image patch 302 from the image patches 216, an epoch can be recorded, e.g., indicating a complete training iteration.

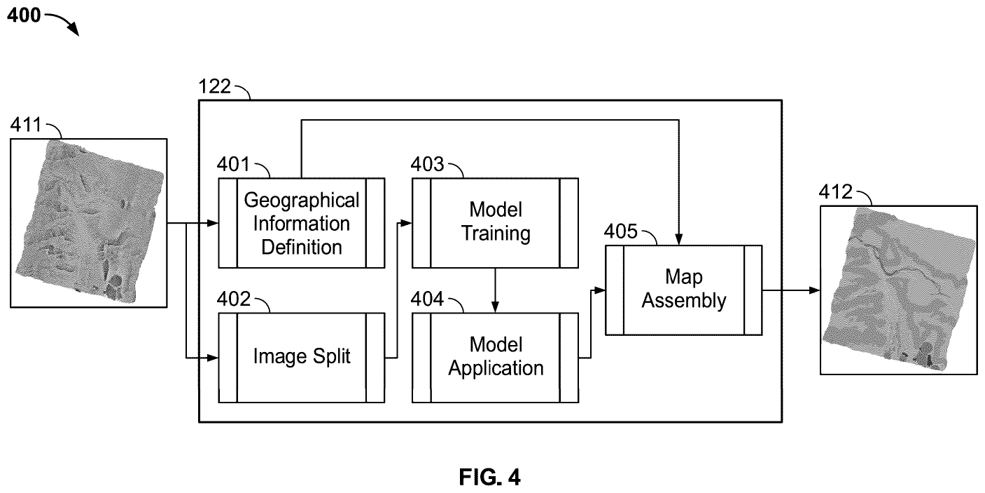

FIG. 4 depicts an example landcover map system 400 for image translation from aerial images 411 (e.g., a UAV-based orthomosaic image 411) of an environment 102 into landcover maps 412 for the environment 102, according to an implementation of the present disclosure. The image translation includes converting one type of image patch (e.g., a patch of an RGB aerial image) to another type of data item, e.g., a patch of landcover map. The system 400 includes geographical information definition module 401 (e.g., an example of a geographic data module 124), image processor module 402 (e.g., an example of an image processor 126), model training module 403 (e.g., an example of a training module 128), model application module 404 (e.g., an example of a module that includes the cGAN 130), and map assembly module 405 (e.g., an example of a map assembly module 132). The above-referenced modules can be collectively referred to as “the modules” and all modules may be embodied as computer program code executable on one or more central or graphical processor units (e.g., CPUs 202 or GPUs 204 shown in FIG. 2A). Two or more of these modules may also be joined by a connection, e.g., a wired connection, a wireless connection. In some implementations, the modules can be distributed among multiple computing devices 120.

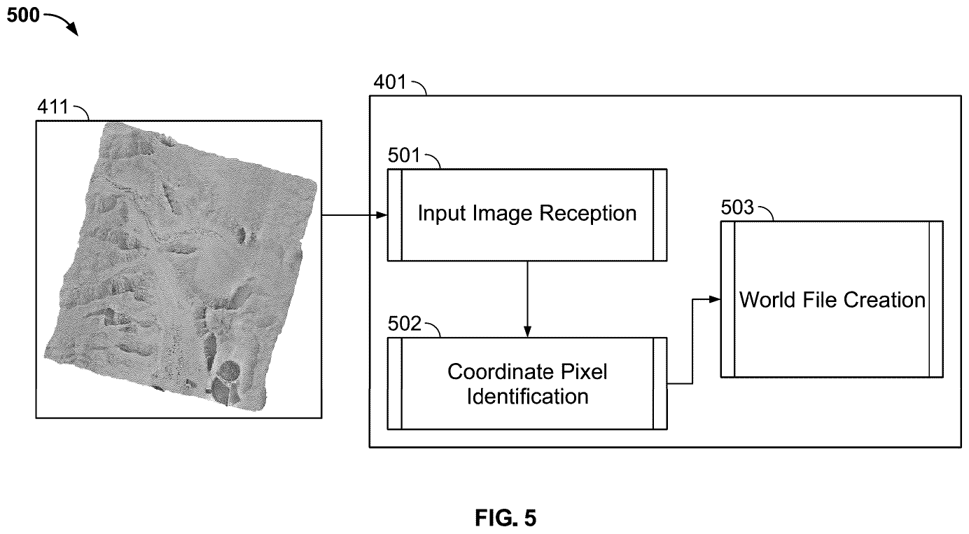

FIG. 5 depicts an example geographical information module of the landcover map system of FIG. 4, according to an implementation of the present disclosure. A diagram 500 shows an example geographical information module 401 of the landcover map system of FIG. 4. The geographical information definition module 401 includes an input image reception module 501, coordinate pixel identification module 502, and world file creation module 503. The geographical information module 401 can receive the input orthomosaic image 411 and preserve original geographical coordinates using a standardized “world file” format. The image reception module 501 can receive the UAV-based RGB orthomosaic image 411 in any suitable format, such as Portable Network Graphics (PNG), Joint Photographic Experts Group (JPEG), Bitmap (BMP), or other image types. An orthomosaic image can have a Geographic Tagged Image File Format (TIFF) that combines geographic metadata, including coordinate information in any appropriate coordinate system. In some cases, the coordinate information can include projected coordinate systems (e.g., transformations from geographic coordinates such as latitude and longitude). The image reception module 501 can receive an orthomosaic image 411 in at any pixel size and/or resolution. For example, the orthomosaic image 411 can be a 4 km by 4.5 km orthomosaic image at a 50-centimeter pixel resolution, which can have a total resolution of 8000 pixels by 9000 pixels (e.g., a size of the image) with three channels (red-green-blue). In some cases, an orthomosaic image 411 can include a single channel (e.g., one channel) or multiple channels for different colors.

FIG. 6 depicts an example coordinate pixel identification module 502 of the geographical information module 401 of FIGS. 4 and FIG. 5, according to an implementation of the present disclosure. A diagram 600 shows the coordinate pixel identification module 502 configured to obtain geographical coordinates information of the top-left pixel of the input image 411. A landcover map engine 122 (e.g., described in reference to FIGS. 1 and 2A above) can be configured to determine coordinate measures, such as rotation, pixel size, pixel coordinates, centers of pixel coordinates, and other measures of pixels in reference to coordinate information of the input image. As an example, the information recorded by 502 is illustrated in FIG. 6 includes pixel size of the orthomosaic image in x-direction (e.g., a map unit or pixel) 601, pixel rotation about a y-axis 602, pixel rotation about x-axis 603, pixel size of the orthomosaic image in y-direction 604 (e.g., along an axis perpendicular to the x-axis), center x-coordinate of the top-left pixel 606, and center y-coordinate of the top left pixel 606.

After obtaining information from coordinate pixel identification module 502, a world file creation module 503 can be configured to process the information and generate a six-line American Standard Code for Information Interchange (ASCII) file containing formatted coordinate information, e.g., 601, 602, 603, 604, 605, and 606.

For example, the ASCII file can include pixel size of the orthomosaic image in x-direction 601 in a first column, pixel rotation about y-axis 602 in a second column, pixel rotation about x-axis 603 in a third column, pixel size of the orthomosaic image in y-direction 606 in a fourth column, center x-coordinate of the top-left pixel 605 in a fifth column, and center y-coordinate of the top-left pixel 606 in a sixth column. The ASCII file can also include the information for 601 through 606 as rows. The world file creation module 503 can be configured to generate (e.g., including saving the file) the ASCII files in a standardized world file format but can also include file formats such as “.gifw,” “.gfw,” “.jpgw,” “.jpw,” “.jp2w,” “.j2w,” “.pngw,” “.pgw,” “.tif,” “.tfw,” and “.wld.”

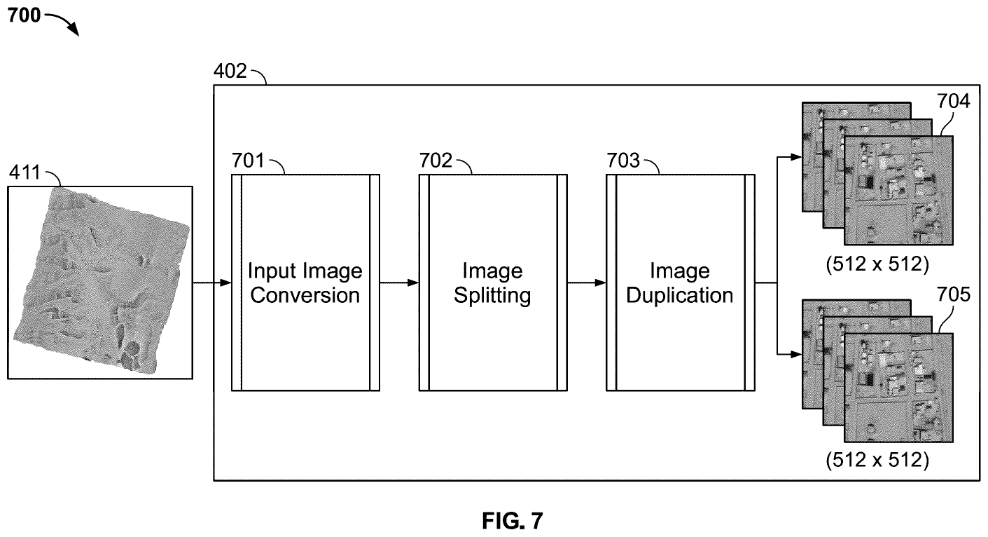

FIG. 7 depicts an example image processing module 402 of the landcover map system of FIG. 4, according to an implementation of the present disclosure. The image processing module 402 can be an example of image processor 126. A diagram 700 shows the image processing module 402 having an input image conversion module 701, image splitting module 702, and image duplication module 703 to generate output image patches 704 and the duplicates image patches 705, which are a duplicate of the output image patches 704. Each patch from the patches 704 and 705 can be a size of 512 pixels×512 pixels. The input image conversion module 701 can receive and convert the UAV-based RGB orthomosaic image 411 from any suitable format, e.g., PNG, JPEG, BMP, Geographic Tagged Image File Format (TIFF), into a file format without geospatial information (e.g., PNG, JPEG).

Similar to the input image reception module 501, the image conversion module 701 can receive the orthomosaic image 411 at any original resolution. The image splitting module 702 can receive a converted image from input image conversion module 701 and split the converted image into smaller, equal-sized image patches. The patches can overlap or non-overlap in any arbitrary pixel size smaller than the input orthomosaic image 411. For example, a 4 km by 4 km orthomosaic image 411 at 50 cm pixel resolution (8000 pixels by 8000 pixels) can be split into 512 pixels by 512 pixels, resulting in 245 image patches, in which the last image patch has a ˜14% overlap with nearby image patches. The image duplication module 703 can duplicate (e.g., copy) of all image patches and resize them (the original image patches and the duplicate image patches) to 512×512 pixels images, e.g., the output image patches 704 and the duplicates image patches 705. In some cases, the duplicate image patches can share an identical resolution, pixel size, etc.

FIG. 8 depicts an example model training module 403 of the landcover map system of FIG. 4, according to an implementation of the present disclosure. The model training module 403 can be an example of a training module 128, described in reference to FIG. 2A above. A diagram 800 shows the model training module 403 having an image selection sub-module 801, image labeling sub-module 802, image augmentation sub-module 803, and cGAN training sub-module 804.

The image selection sub-module 801 can select some image patches from the image patches 704 and the corresponding duplicates 705 for training. An advantage of training cGAN is that as few as 40 image patches (80 including the respective duplicate patches) may be sufficient for training, e.g., in contrast to hundreds or thousands of images for training techniques that perform pixel-level classification. In some implementations, patches can be selected to equally cover multiple landcover classes captured in the input image. The image selection module 801 can be configured to randomly select the patches or select patches according to criteria including feature density and/or the presence of a target landcover.

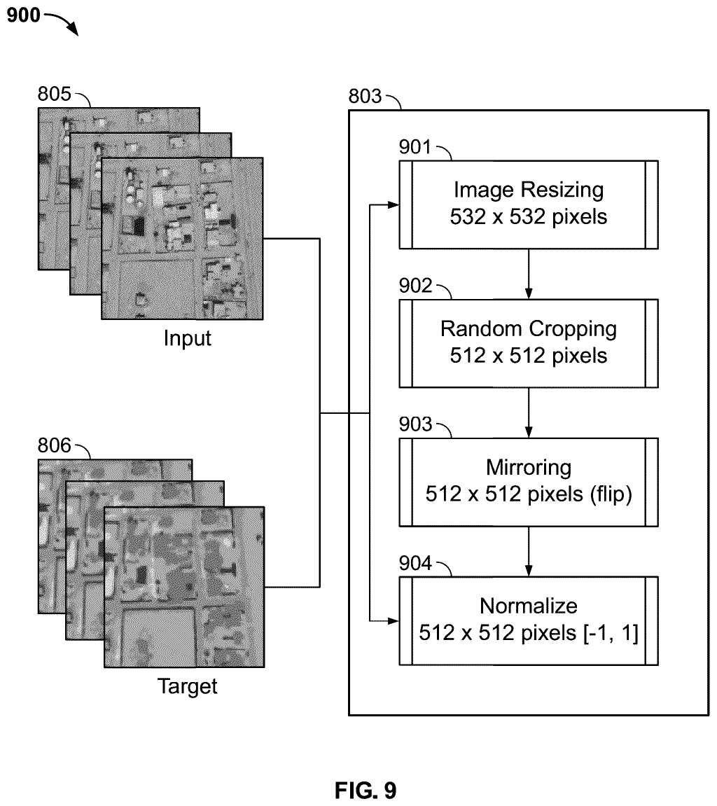

For example, the techniques described in this disclosure may be configured to generate a target landcover class. The image labeling sub-module 802 may color-label the duplicate patch of the selected image patch with a known landcover. In some implementations, the labeling can be performed manually, by computer-aided hand drawing, automatically employing a mathematical approach, or some combination thereof. An initial selection for an image patch from the image patches 704 is depicted in FIG. 8 as an “input image patch 805” or “input patch 805” and the labeled duplicates image patch is depicted as “target landcover patch 806” or “target patch 806.” Both the input patch 805 and the target patch 806 can be provided to the image augmentation sub-module 803, described in reference to FIG. 9 below.

FIG. 9 depicts an example image augmentation submodule 803 of the model training module 403 of FIG. 8, according to an implementation of the present disclosure. The image augmentation sub-module 803 can be part of an image processor 126, described in reference to FIG. 2A above. A diagram 900 shows the image augmentation sub-module 803 having an image resizing module 901, random cropping module 902, mirroring module 903, and image normalization module 904. The image resizing module 901 can resize the input patch 802 and the target patch 806 into a particular image size, e.g., 532×532 pixels, using a number of re-sizing techniques to interpolate feature data for the patches. In some implementations, the image re-sizing module 901 can be configured to apply a nearest neighbor technique to generate data for resized images. The random cropping module 902 can be configured to randomly-crop the resized input patch 805 and the resized target patch 806 into a 512×512 pixels image. The mirroring module 603 may flip the cropped input patch 805 and the cropped target patch 806 horizontally, vertically, or both horizontally and vertically.

The image normalization module 904 can be configured to normalize the RGB values of all image patches (original and augmented) into a range of values, e.g., −1 to 1 range. The image normalization module 904 can be configured to perform an embedding process to normalize the RGB values into a smaller dimensional space than an original dimension of the RGB values. By embedding the feature data of the image patches (e.g., input patches 805 and target patches 806), the image normalization module 904 can be configured to perform a dimensional reduction that maintains a majority of feature data that facilitate training and inference tasks for the cGAN 130. For example, an embedding can reduce sparsity and provides data in a vector format that can be more readily processed by the cGAN 130. A compact representation of the feature data can improve computational efficiency by compacting categorical (semantic) data into numerical, vector-based data, which is inherently processed more efficiently by machine learning networks such as the cGAN 130.

FIG. 10 depicts an example cGAN submodule 804 of the model training module of FIG. 8, according to an implementation of the present disclosure. A diagram 1000 shows the cGAN training sub-module 804 having a generator training module 1001 linked to a discriminator training module 1002 through a discriminator network 1004. The generator training module 1001 includes a generator network 1003, a mean absolute error computation 1006, a constant lambda multiplier value 1007 (e.g., a value of λ=100), a sigmoid cross entropy 1002 between a product of the discriminator network 1004 (e.g., an array of ones), and a gradient optimizer 1009 that can be configured to use a solver with a tuning parameter such as target learning rate (e.g., a learning rate of 0.0002) to minimize a loss function.

The discriminator training module 1002 includes the discriminator network 1010, a sigmoid cross entropy 1011 between a product of the discriminator network 1004 and an array of zeroes, a sigmoid cross entropy 1012 between a product of discriminator network 1010 and an array of ones, and a gradient optimizer 1013 that be configured to use a solver with a tuning parameter, such as a target learning rate.

The generator training module 1001 can be configured to generate an image patch from an input image patch to the style of the target landcover patch (e.g., translating from aerial image patches to landcover map patches), while the discriminator training module 1002 can be configured to evaluate, patch-by-patch, the styled image resulting from the generator training module 1001. The training for the generator network 1003 and discriminator networks 1004 and 1010 can be done sequentially, e.g., one-step of generator training module 1001, followed by one-step discriminator training module 1002. A complete training iteration of the cGAN for all input patches 805 and respective target landcover patches 806 can be referred to as an epoch 1005. The output of cGAN training sub-module 804 can be a generator network 1003 trained with a number of epochs that meets a threshold error rate between a ground truth measurement and a target landcover patch for a landcover map, e.g., 800 to 1000 epochs.

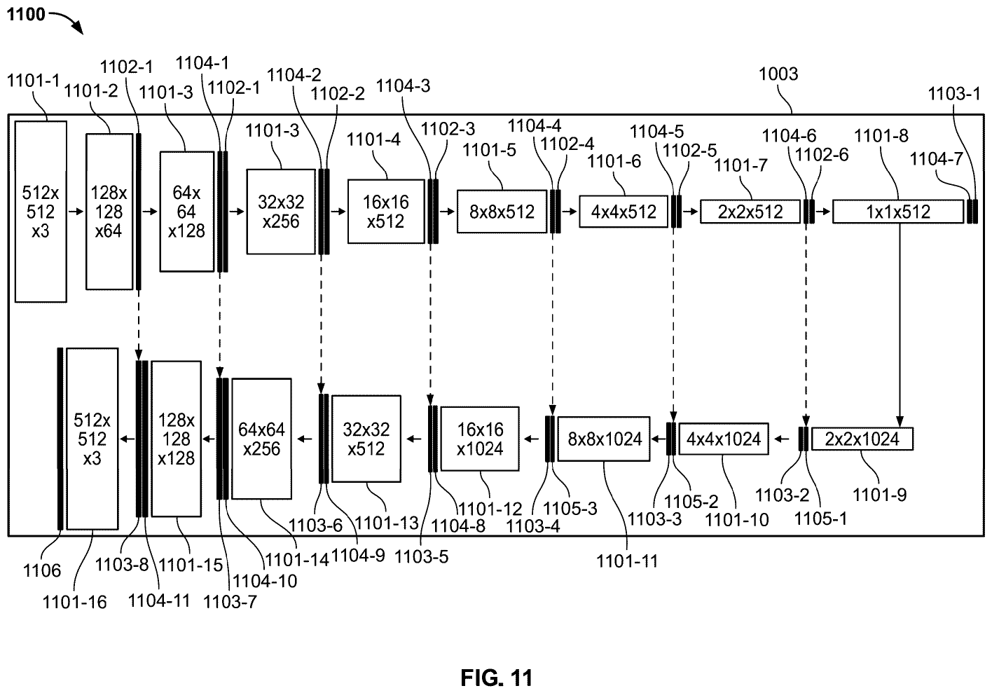

FIG. 11 depicts an example generator network 1003 of the cGAN submodule of FIG. 10, according to an implementation of the present disclosure. The generator training module 1001 trains the generator network 1003 depicted in FIGS. 10 and 11. A diagram 1100 shows the generator network 1003 having a modified U-Net architecture that utilizes 4×4 spatial filters, a stride of 2, a downward and upward step by factors of 2 (with exception to the first and the last layer of the generator network 1003) and skip connections. Referring to FIG. 11, each block 1101 represents the data size of the convolutional neural network (CNN) layer (also referred to as “convolutional neural network layers”) and can include a number of blocks 1101-1 through 1101-16 (collectively “CNN layers 1101”).

As an example, the input for generator network 1003 is an input image patch of 512×512 pixels in RGB (e.g., three-channel). The first CNN block 1101-1 depicted in FIG. 11 shows a size of 512×512×3. Each pass of the CNN layer (e.g., from one or more convolutional neural network layers) adjusts the size of the data as the CNN layer processes feature data in the image patch. However, the output of generator network 1003 maintains a similar dimension to the input patch (e.g., 512 pixels×512 pixels×3 channels). Referring to FIG. 11, the downward part of block 1101-1 is followed by leaky ReLU activation function 1102-2 with a slope of 0.2, while the upward part of 1101-1 is followed by ReLU activation function 1103. For some part of the block 1101-1, a batch normalization 1104 and/or batch normalization that includes a dropout 1105 is applied before the ReLU activation function 1103. The last upward block 1101-16 includes an activation function 1106. An activation function (e.g., ReLU activation function 1103, activation function 1106, leaky ReLU activation function 1102-2) can be referred to as an activation layer, e.g., one or more activation layers. In some cases, the activation function is a hyperbolic tangent function 1106. An initial weight for the blocks 1101 can be randomized using a Gaussian distribution, e.g., a mean of 0 and a standard deviation of 0.02.

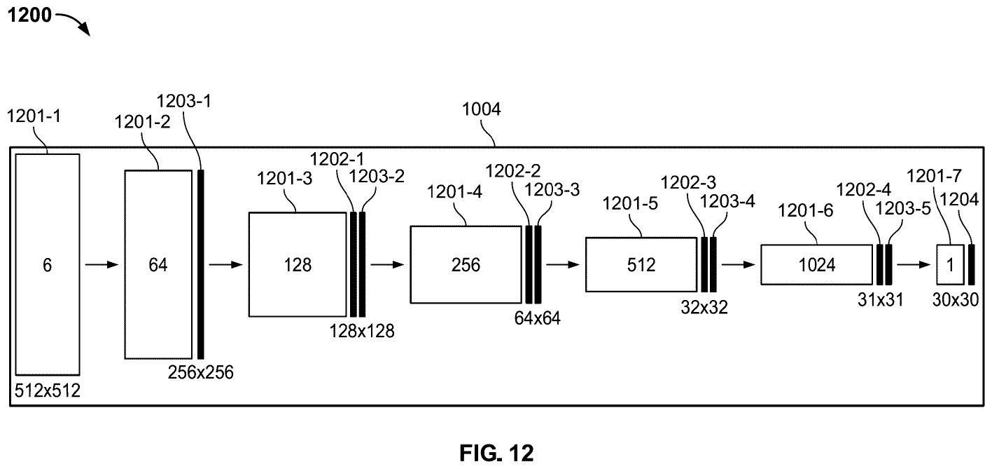

FIG. 12 depicts an example discriminator network 1004 of the cGAN submodule of FIG. 10, according to an implementation of the present disclosure. The configuration of discriminator network 1010 can also match the configuration of discriminator network 1004 depicted in FIG. 12. The discriminator training module 1002 trains the discriminator network 1004 and discriminator network 1010. The discriminator networks 1004 and 1010 can be modified CNNs that evaluate whether the image patch is real or not, patch by patch, of the landcover image patches generated by the GAN.

A diagram 1200 shows the first block 1201-1 of the discriminator 1004 having a stacked image input, e.g., an input patch 805 and a target patch 806 are provided to discriminator network 1010 at a size of 512 pixels×512 pixels×3 channels. The first block 1201-1 for the discriminator network 1010 is thus 512×512×6 channels. Each pass of the CNN adjusts the size of the landcover patch from block 1201-1 to block 1201-7. The size of the patch of the last block 1201-7 is 30 pixels×30 pixels×1 channel, which evaluates 70 pixels×70 pixels of the landcover image patch. Some blocks depicted in FIG. 12 are followed by batch normalization 1202, a leaky ReLU activation function 1203 with a slope of 0.2, and/or a sigmoid activation function 1204.

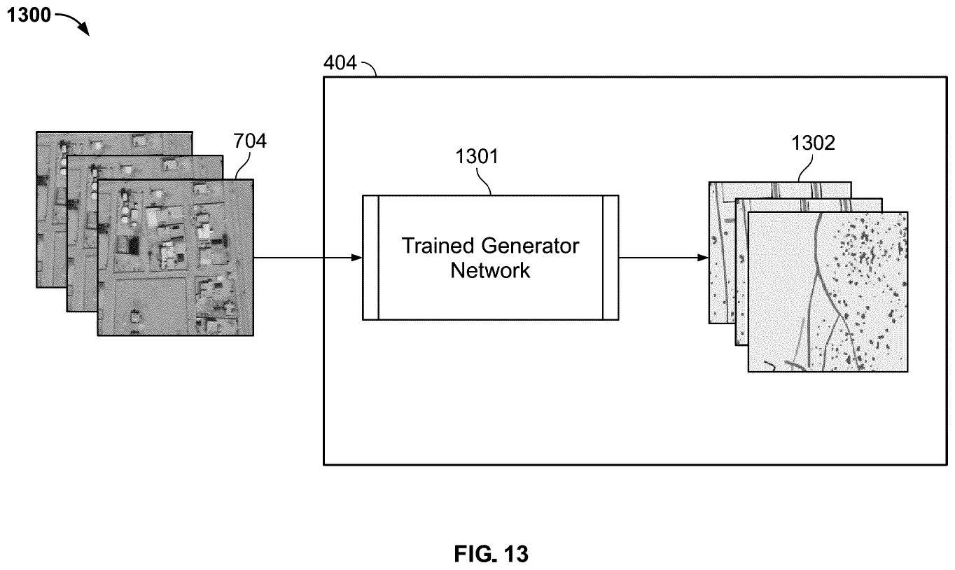

FIG. 13 depicts an example model application module 404 of the landcover map system of FIG. 4, according to an implementation of the present disclosure. A diagram 1300 shows the model application module 404 obtaining an input patch 704 and output a landcover map patch 1302 by providing the input patch 704 to the trained generator adversarial network 1301, e.g., described in reference to FIGS. 2A, 3 and 4. The trained generator adversarial network 1301 includes the generator network 1003 at the epoch number that satisfies the cGAN training sub-module 804, e.g., below a threshold error rate.

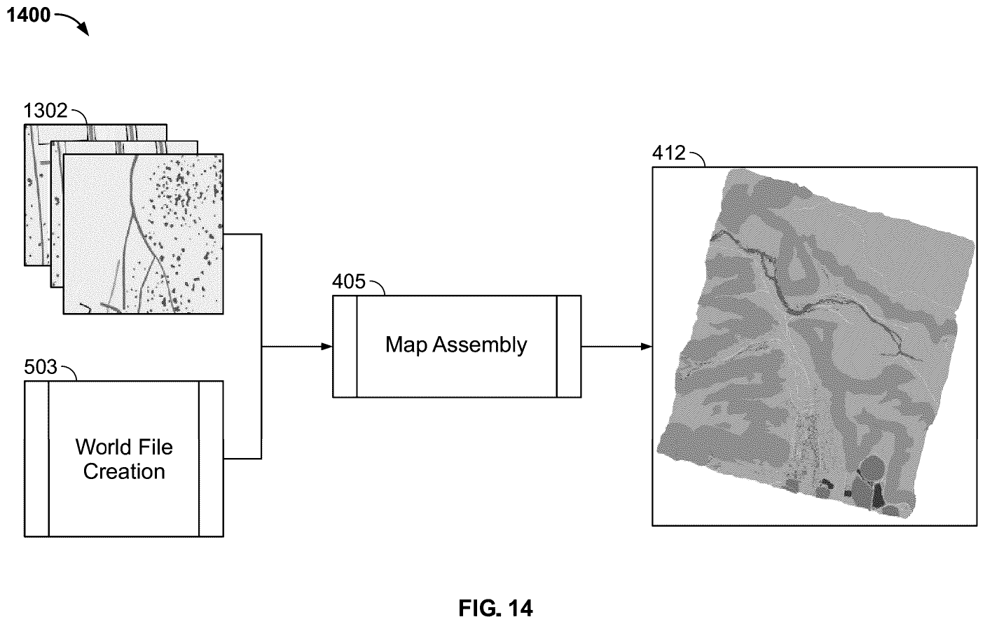

FIG. 14 depicts an example landcover map assembly module 405 of the landcover map system of FIG. 4, according to an implementation of the present disclosure. A diagram 1400 shows the map assembly module 404 configured to re-assemble landcover image patch 1302 into a landcover map 412 with a similar image size to the input UAV-based RGB Orthomosaic image 411. The landcover map 412 includes the associated geographical coordinates from world files, e.g., generated by world file creation sub-module 503 of the geographical information definition module 401. Each color (e.g., a color channel) of the landcover map 412 represents a particular landcover class and can be converted into a geographical information system (GIS) polygon feature, e.g., by a computing device 120 through the landcover map engine 122.

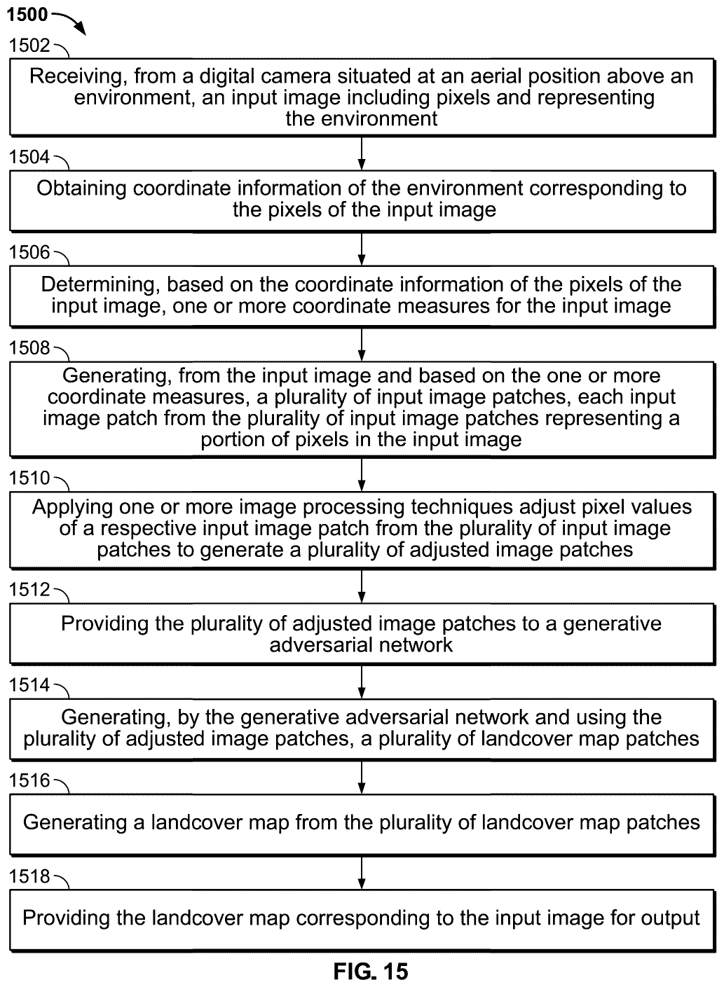

FIG. 15 illustrates an example process 1500 for generating landcover maps of an environment using a generative adversarial network and aerial images of the environment, according to an implementation of the present disclosure. For example, a computing device 120 can be configured to perform process 1500, e.g., generating landcover maps 134 of an environment 102 using input images 116. In some implementations, the process 1500 is performed by a data processing system. Such a data processing system is subsequently described in more detail in relation to FIG. 17.

In step 1502, the data processing system receives an input image (e.g., input image(s) 116 of FIG. 1) that includes pixels representing the environment, e.g., an environment 102. The input image can be received through a communication network (e.g., communication network 112) and from a digital camera situated at an aerial position above an environment. In some implementations, the input image is an orthomosaic image captured by an unmanned aerial vehicle (e.g., UAV 104 of FIG. 1) and the coordinate information is obtained from the unmanned aerial vehicle. In some implementations, the input image is a satellite image captured by a satellite (e.g., satellite 108 of FIG. 1) and the coordinate information is obtained from the satellite. In some implementations, one or more channels of the input images can include a frequency band. The frequency band can be any portion of the electromagnetic spectrum, such as visible light, infrared, etc.

In step 1504, the data processing system obtains coordinate information of the environment corresponding to the pixels of the input image. Coordinate information can include coordinate data 114 of FIG. 1, which can include geographical position information (e.g., latitude, longitude) of the environment that corresponds to the captured input image.

In step 1506, the data processing system determines, based on the coordinate information of the pixels of the input image, one or more coordinate measures for the input image. The coordinate measures can include one or more of (i) a pixel size, (ii) a pixel size, (iii) a pixel coordinate, (iv) a pixel rotation about an axis of the input image, for one or more pixels of the input image.

In step 1508, the data processing system generates, from the input image and based on the one or more coordinate measures, a plurality of input image patches, each input image patch from the plurality of input image patches representing a portion of pixels in the input image. Examples of the input image patches can include image patches 208, 216. In some implementations, generating the plurality of input image patches includes removing the coordinate information from the input image and selecting, for each input image patch in the plurality of input image patches, a portion of pixels of the input image. Each input image patch in the plurality of input image patches can share an identical resolution. The step 1508 can include generating a second set of input image patches from the plurality of input image patches, in which each input image patch in the second set of input image patches is a duplicate of a corresponding input image patch in the plurality of input image patches, e.g., from an image duplication module 703. In some implementations, the plurality of input image patches are non-overlapping.

In step 1510, the data processing system applies, for the plurality of input image patches, one or more image processing techniques to adjust pixel values of a respective input image patch from the plurality of input image patches to generate a plurality of adjusted image patches. The image processing techniques can be performed by an image processor 126 of FIG. 1, and can include image enhancement, histogram equalization, edge sharpening, noise reduction, resizing, normalization, data augmentation (e.g., rotation, flipping, cropping, translation).

In step 1512, the data processing system provides the plurality of adjusted image patches to a generative adversarial network. The generative adversarial network (GAN) is trained to generate a corresponding landcover map patch for each adjusted image patch in the plurality of adjusted image patches. The generative adversarial network can be a conditional generative adversarial network. The GAN includes a generator network (e.g., generator network 1003 of FIG. 10) that further includes a plurality of convolutional neural network layers, a plurality of skip connections, and a plurality of activation layers. The GAN includes a discriminator network (e.g., discriminator networks 1004, 1010 of FIG. 10) that further includes a plurality of convolutional neural network layers and a plurality of activation layers.

In step 1514, the data processing system generates, by the generative adversarial network and using the plurality of adjusted image patches, a plurality of landcover map patches. The generative adversarial network includes a generator network trained to generate training landcover map patches from an input image patch and a discriminator network trained to classify training landcover map patches from the generator network. A classification of a training landcover map patch comprises a label indicating that the training landcover map patch represents one or more landcover classes of a corresponding input image patch.

In step 1516, the data processing system generates a landcover map from the plurality of landcover map patches. Generating the landcover map includes assembling the plurality of landcover map patches according to the coordinate information of the environment. The landcover map includes one or more landcover classification labels, each classification label from the one or more landcover classification labels corresponding to a landcover class of the environment. In some implementations, at least one classification label from the one or more landcover classification labels represent an obstructed portion of the environment, the obstructed portion of the environment being likely to cause an interference in seismic imaging of the environment.

In step 1518, the data processing system provides the landcover map corresponding to the input image for output. In some implementations, providing the landcover map includes transmitting the landcover map to a client device, for display of the landcover map on the client device. In some implementations, providing the landcover map includes transmitting the landcover map to a computing device configured to determine positions of seismic imaging equipment according to the landcover map.

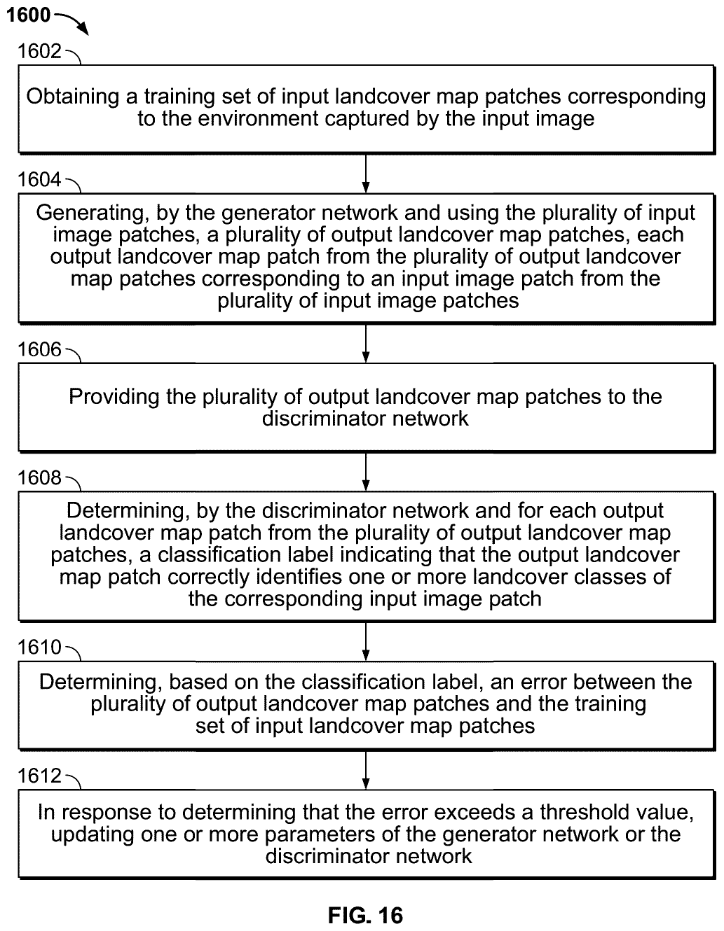

FIG. 16 illustrates an example process 1600 for training the generative adversarial network, according to an implementation of the present disclosure. For example, a computing device 120 can be configured to perform process 1600, e.g., training the GAN 130. In some implementations, the process 1600 is performed by a data processing system. Such a data processing system 1600 is subsequently described in more detail in relation to FIG. 17.

In step 1602, the data processing system obtains a training set of input landcover map patches corresponding to the environment captured by the input image.

In step 1604, the data processing system generates, by the generator network and using the plurality of input image patches, a plurality of output landcover map patches, each output landcover map patch from the plurality of output landcover map patches corresponding to an input image patch from the plurality of input image patches.

In step 1606, the data processing system provides the plurality of output landcover map patches to the discriminator network.

In step 1608, the data processing system determines, by the discriminator network and for each output landcover map patch from the plurality of output landcover map patches, a classification label indicating that the output landcover map patch correctly identifies one or more landcover classes of the corresponding input image patch.

In step 1610, the data processing system determines, based on the classification label, an error between the plurality of output landcover map patches and the training set of input landcover map patches.

In step 1612, the data processing system updates one or more parameters of the generator network or the discriminator network in response to determining that the error exceeds a threshold value.

FIG. 17 is a block diagram of an example data processing system 1700 according to an implementation of the present disclosure. The data processing system 1700 is used to provide computational functionalities associated with described algorithms, methods, functions, processes, flows, and procedures described in the present disclosure, according to some implementations of the present disclosure. The illustrated computer 1702 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 1702 can include input devices such as keypads, keyboards, and touch screens that can accept user information. Also, the computer 1702 can include output devices that can convey information associated with the operation of the computer 1702. The information can include digital data, visual data, audio information, or a combination of information. The information can be presented in a graphical user interface (UI) (or GUI).

The computer 1702 can serve in a role as a client, a network component, a server, a database, a persistency, or components of a computer system for performing the subject matter described in the present disclosure. The illustrated computer 1702 is communicably coupled with a network 1724. In some implementations, one or more components of the computer 1702 can be configured to operate within different environments, including cloud-computing-based environments, local environments, global environments, and combinations of environments.

At a high level, the computer 1702 is an electronic computing device operable to receive, transmit, process, store, and manage data and information associated with the described subject matter. According to some implementations, the computer 1702 can also include, or be communicably coupled with, an application server, an email server, a web server, a caching server, a streaming data server, or a combination of servers.

The computer 1702 can receive requests over network 1724 from a client application (for example, executing on another computer 1702). The computer 1702 can respond to the received requests by processing the received requests using software applications. Requests can also be sent to the computer 1702 from internal users (for example, from a command console), external (or third) parties, automated applications, entities, individuals, systems, and computers.

Each of the components of the computer 1702 can communicate using a system bus 1704. In some implementations, any or all of the components of the computer 1702, including hardware or software components, can interface with each other or the interface 1706 (or a combination of both), over the system bus 1704. Interfaces can use an application programming interface (API) 1714, a service layer 1716, or a combination of the API 1714 and service layer 1716. The API 1714 can include specifications for routines, data structures, and object classes. The API 1714 can be either computer-language independent or dependent. The API 1714 can refer to a complete interface, a single function, or a set of APIs.

The service layer 1716 can provide software services to the computer 1702 and other components (whether illustrated or not) that are communicably coupled to the computer 1702. The functionality of the computer 1702 can be accessible for all service consumers using this service layer. Software services, such as those provided by the service layer 1716, can provide reusable, defined functionalities through a defined interface. For example, the interface can be software written in JAVA, C++, or a language providing data in extensible markup language (XML) format. While illustrated as an integrated component of the computer 1702, in alternative implementations, the API 1714 or the service layer 1716 can be stand-alone components in relation to other components of the computer 1702 and other components communicably coupled to the computer 1702. Moreover, any or all parts of the API 1714 or the service layer 1716 can be implemented as child or sub-modules of another software module, enterprise application, or hardware module without departing from the scope of the present disclosure.

The computer 1702 includes an interface 1706. Although illustrated as a single interface 1706 in FIG. 17, two or more interfaces 1706 can be used according to particular needs, desires, or particular implementations of the computer 1702 and the described functionality. The interface 1706 can be used by the computer 1702 for communicating with other systems that are connected to the network 1724 (whether illustrated or not) in a distributed environment. Generally, the interface 1706 can include, or be implemented using, logic encoded in software or hardware (or a combination of software and hardware) operable to communicate with the network 1724. More specifically, the interface 1706 can include software supporting one or more communication protocols associated with communications. As such, the network 1724 or the hardware of the interface can be operable to communicate physical signals within and outside of the illustrated computer 1702.

The computer 1702 includes a processor 1708. Although illustrated as a single processor 1708 in FIG. 17, two or more processors 1708 can be used according to particular needs, desires, or particular implementations of the computer 1702 and the described functionality. Generally, the processor 1708 can execute instructions and can manipulate data to perform the operations of the computer 1702, including operations using algorithms, methods, functions, processes, flows, and procedures as described in the present disclosure.

The computer 1702 also includes a database 1720 that can hold data (for example, seismic data 1722) for the computer 1702 and other components connected to the network 1724 (whether illustrated or not). For example, database 1720 can be an in-memory, conventional, or a database storing data consistent with the present disclosure. In some implementations, database 1720 can be a combination of two or more different database types (for example, hybrid in-memory and conventional databases) according to particular needs, desires, or particular implementations of the computer 1702 and the described functionality. Although illustrated as a single database 1720 in FIG. 17, two or more databases (of the same, different, or combination of types) can be used according to particular needs, desires, or particular implementations of the computer 1702 and the described functionality. While database 1720 is illustrated as an internal component of the computer 1702, in alternative implementations, database 1720 can be external to the computer 1702.

The computer 1702 also includes a memory 1710 that can hold data for the computer 1702 or a combination of components connected to the network 1724 (whether illustrated or not). Memory 1710 can store any data consistent with the present disclosure. In some implementations, memory 1710 can be a combination of two or more different types of memory (for example, a combination of semiconductor and magnetic storage) according to particular needs, desires, or particular implementations of the computer 1702 and the described functionality. Although illustrated as a single memory 1710 in FIG. 17, two or more memories 1710 (of the same, different, or combination of types) can be used according to particular needs, desires, or particular implementations of the computer 1702 and the described functionality. While memory 1710 is illustrated as an internal component of the computer 1702, in alternative implementations, memory 1710 can be external to the computer 1702.

The application 1712 can be an algorithmic software engine providing functionality according to particular needs, desires, or particular implementations of the computer 1702 and the described functionality. For example, application 1712 can serve as one or more components, modules, or applications. Further, although illustrated as a single application 1712, the application 1712 can be implemented as multiple applications 1712 on the computer 1702. In addition, although illustrated as internal to the computer 1702, in alternative implementations, the application 1712 can be external to the computer 1702.

The computer 1702 can also include a power supply 1718. The power supply 1718 can include a rechargeable or non-rechargeable battery that can be configured to be either user-or non-user-replaceable. In some implementations, the power supply 1718 can include power-conversion and management circuits, including recharging, standby, and power management functionalities. In some implementations, the power-supply 1718 can include a power plug to allow the computer 1702 to be plugged into a wall socket or a power source to, for example, power the computer 1702 or recharge a rechargeable battery.

There can be any number of computers 1702 associated with, or external to, a computer system containing computer 1702, with each computer 1702 communicating over network 1724. Further, the terms “client,” “user,” and other appropriate terminology can be used interchangeably, as appropriate, without departing from the scope of the present disclosure. Moreover, the present disclosure contemplates that many users can use one computer 1702 and one user can use multiple computers 1702.

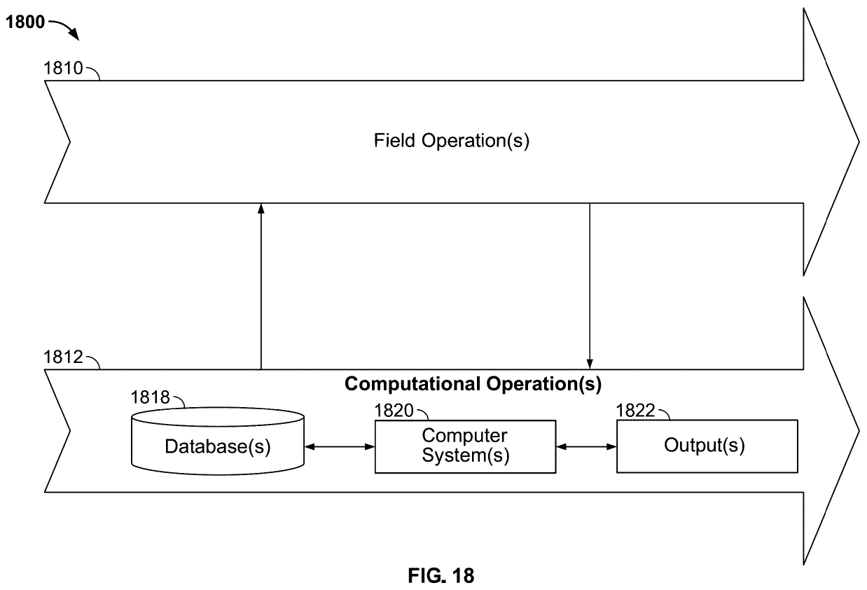

FIG. 18 illustrates hydrocarbon production operations 1800 that include both one or more field operations 1810 and one or more computational operations 1812, which exchange information and control exploration for the production of hydrocarbons, according to an implementation of the present disclosure. In some implementations, outputs of techniques of the present disclosure can be performed before, during, or in combination with the hydrocarbon production operations 1800, specifically, for example, either as field operations 1810 or computational operations 1812, or both.

Examples of field operations 1810 include forming/drilling a wellbore, hydraulic fracturing, producing through the wellbore, injecting fluids (such as water) through the wellbore, to name a few. In some implementations, methods of the present disclosure can trigger or control the field operations 1810. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 1810 and responsively triggering the field operations 1810 including, for example, generating plans and signals that provide feedback to and control physical components of the field operations 1810. Alternatively or in addition, the field operations 1810 can trigger the methods of the present disclosure. For example, implementing physical components (including, for example, hardware, such as sensors) deployed in the field operations 1810 can generate plans and signals that can be provided as input or feedback (or both) to the methods of the present disclosure.

Examples of computational operations 1812 include one or more computer systems 1820 that include one or more processors and computer-readable media (e.g., non-transitory computer-readable media) operatively coupled to the one or more processors to execute computer operations to perform the methods of the present disclosure. The computational operations 1812 can be implemented using one or more databases 1818, which store data received from the field operations 1810 and/or generated internally within the computational operations 1812 (e.g., by implementing the methods of the present disclosure) or both. For example, the one or more computer systems 1820 process inputs from the field operations 1810 to assess conditions in the physical world, the outputs of which are stored in the databases 1818.

In some implementations, one or more outputs 1822 generated by the one or more computer systems 1820 can be provided as feedback/input to the field operations 1810 (either as direct input or stored in the databases 1818). The field operations 1810 can use the feedback/input to control physical components used to perform the field operations 1810 in the real world.

In some implementations of the computational operations 1812, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart or are located in different countries or other jurisdictions.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware-or software-based (or a combination of both hardware-and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing

computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple embodiments separately or in any suitable sub-combination.

A number of embodiments have been described. Nevertheless, it will be understood that various modifications may be made without departing from the scope of the data processing system described herein. Accordingly, other embodiments are within the scope of the following claims.

1. A computer-implemented method for landcover map generation, comprising:
receiving, by a communication network and from a digital camera situated at an aerial position above an environment, an input image comprising pixels and representing the environment;
obtaining coordinate information of the environment corresponding to the pixels of the input image;
determining, based on the coordinate information of the pixels of the input image, one or more coordinate measures for the input image;
generating, from the input image and based on the one or more coordinate measures, a plurality of input image patches, each input image patch from the plurality of input image patches representing a portion of pixels in the input image;
applying, for the plurality of input image patches, one or more image processing techniques to adjust pixel values of a respective input image patch from the plurality of input image patches to generate a plurality of adjusted image patches;
providing the plurality of adjusted image patches to a generative adversarial network, wherein the generative adversarial network is trained to generate a corresponding landcover map patch for each adjusted image patch in the plurality of adjusted image patches;
generating, by the generative adversarial network and using the plurality of adjusted image patches, a plurality of landcover map patches, wherein the generative adversarial network comprises a generator network trained to generate training landcover map patches from an input image patch and a discriminator network trained to classify training landcover map patches from the generator network, wherein a classification of a training landcover map patch comprises a label indicating that the training landcover map patch represents one or more landcover classes of a corresponding input image patch;
generating a landcover map from the plurality of landcover map patches, wherein generating the landcover map comprises assembling the plurality of landcover map patches according to the coordinate information of the environment; and
providing the landcover map corresponding to the input image for output.

2. The computer-implemented method of claim 1, wherein providing the landcover map comprises transmitting the landcover map to a client device, for display of the landcover map on the client device.

3. The computer-implemented method of claim 1, wherein providing the landcover map comprises transmitting the landcover map to a computing device configured to determine positions of seismic imaging equipment according to the landcover map.

4. The computer-implemented method of claim 1, wherein the landcover map comprises one or more landcover classification labels, each classification label from the one or more landcover classification labels corresponding to a landcover class of the environment.

5. The computer-implemented method of claim 4, wherein at least one classification label from the one or more landcover classification labels represent an obstructed portion of the environment, the obstructed portion of the environment being likely to cause an interference in seismic imaging of the environment.

6. The computer-implemented method of claim 1, wherein the input image is an orthomosaic image captured by an unmanned aerial vehicle and the coordinate information is obtained from the unmanned aerial vehicle.

7. The computer-implemented method of claim 1, wherein the input image is a satellite image captured by a satellite and the coordinate information is obtained from the satellite.

8. The computer-implemented method of claim 1, wherein the coordinate measures comprise one or more of (i) a pixel size, (ii) a pixel size, (iii) a pixel coordinate, (iv) a pixel rotation about an axis of the input image, for one or more pixels of the input image.

9. The computer-implemented method of claim 1, wherein generating the plurality of input image patches from the input image comprises:
removing the coordinate information from the input image;
selecting, for each input image patch in the plurality of input image patches, a portion of pixels of the input image, wherein each input image patch in the plurality of input image patches share an identical resolution; and
generating a second set of input image patches from the plurality of input image patches, wherein each input image patch in the second set of input image patches is a duplicate of a corresponding input image patch in the plurality of input image patches.

10. The computer-implemented method of claim 9, wherein the plurality of input image patches are non-overlapping.

11. The computer-implemented method of claim 1, wherein the generator network of the generative adversarial network comprises a plurality of convolutional neural network layers, a plurality of skip connections, and a plurality of activation layers.

12. The computer-implemented method of claim 1, wherein the discriminator network of the generative adversarial network comprises a plurality of convolutional neural network layers and a plurality of activation layers.

13. The computer-implemented method of claim 1, wherein one or more channels of the input image comprises a frequency band of visible light.

14. The computer-implemented method of claim 1, wherein one or more channels of the input image comprises a frequency band of infrared.

15. The computer-implemented method of claim 1, wherein the generative adversarial network is a condition generative adversarial network, and comprising:
obtaining a training set of input landcover map patches corresponding to the environment captured by the input image;
generating, by the generator network and using the plurality of input image patches, a plurality of output landcover map patches, each output landcover map patch from the plurality of output landcover map patches corresponding to an input image patch from the plurality of input image patches;
providing the plurality of output landcover map patches to the discriminator network;
determining, by the discriminator network and for each output landcover map patch from the plurality of output landcover map patches, a classification label indicating that the output landcover map patch correctly identifies one or more landcover classes of the corresponding input image patch;
determining, based on the classification label, an error between the plurality of output landcover map patches and the training set of input landcover map patches; and
in response to determining that the error exceeds a threshold value, updating one or more parameters of the generator network or the discriminator network.

16. A computer-implemented system for landcover map generation, comprising:
at least one processor; and
a memory storing instructions that, when executed by the at least one processor, cause the at least one processor to perform operations, comprising:
receiving, by a communication network and from a digital camera situated at an aerial position above an environment, an input image representing the environment, the input image comprising pixels;
obtaining coordinate information of the environment corresponding to the pixels of the input image;
determining, based on the coordinate information of the pixels of the input image, one or more coordinate measures for the input image;
generating, from the input image and based on the one or more coordinate measures, a plurality of input image patches, each input image patch from the plurality of input image patches representing a portion of pixels in the input image;
applying, for the plurality of input image patches, one or more image processing techniques to adjust pixel values of a respective input image patch from the plurality of input image patches to generate a plurality of adjusted image patches;
providing the plurality of adjusted image patches to a generative adversarial network, wherein the generative adversarial network is trained to generate a corresponding landcover map patch for each adjusted image patch in the plurality of adjusted image patches;
generating, by the generative adversarial network and using the plurality of adjusted image patches, a plurality of landcover map patches, wherein the generative adversarial network comprises a generator network trained to generate training landcover map patches from an input image patch and a discriminator network trained to classify training landcover map patches from the generator network, wherein a classification of the training landcover map patch comprises a label indicating that the training landcover map patch represents one or more landcover classes of a corresponding input image patch;
generating a landcover map from the plurality of landcover map patches, wherein generating the landcover map comprises assembling the plurality of landcover map patches according to the coordinate information of the environment; and
providing the landcover map corresponding to the input image for output.

17. The system of claim 16, wherein providing the landcover map comprises transmitting the landcover map to a client device, for display of the landcover map on the client device.

18. The system of claim 16, wherein providing the landcover map comprises transmitting the landcover map to a computing device configured to determine positions of seismic imaging equipment according to the landcover map.

19. One or more non-transitory computer readable media storing instructions for landcover map generation, wherein the instructions, when executed by at least one processor, cause the at least one processor to perform operations, comprising:
receiving, by a communication network and from a digital camera situated at an aerial position above an environment, an input image representing the environment, the input image comprising pixels;
obtaining coordinate information of the environment corresponding to the pixels of the input image;
determining, based on the coordinate information of the pixels of the input image, one or more coordinate measures for the input image;
generating, from the input image and based on the one or more coordinate measures, a plurality of input image patches, each input image patch from the plurality of input image patches representing a portion of pixels in the input image;
applying, for the plurality of input image patches, one or more image processing techniques to adjust pixel values of a respective input image patch from the plurality of input image patches to generate a plurality of adjusted image patches;
providing the plurality of adjusted image patches to a generative adversarial network, wherein the generative adversarial network is trained to generate a corresponding landcover map patch for each adjusted image patch in the plurality of adjusted image patches;
generating, by the generative adversarial network and using the plurality of adjusted image patches, a plurality of landcover map patches, wherein the generative adversarial network comprises a generator network trained to generate training landcover map patches from an input image patch and a discriminator network trained to classify training landcover map patches from the generator network, wherein a classification of the training landcover map patch comprises a label indicating that the training landcover map patch represents one or more landcover classes of a corresponding input image patch;
generating a landcover map from the plurality of landcover map patches, wherein generating the landcover map comprises assembling the plurality of landcover map patches according to the coordinate information of the environment; and
providing the landcover map corresponding to the input image for output.

20. The non-transitory computer readable media of claim 19, wherein providing the landcover map comprises transmitting the landcover map to a client device, for display of the landcover map on the client device.
